(19) United States
(12) Patent Application Publication
(10) Pub. No.: US 2026/0093537 A1
(43) Pub. Date: Apr. 2, 2026

(54) TECHNIQUES FOR RESOURCE ALLOCATION AND MANAGEMENT

(71) Applicant: Dell Products L.P., Hopkinton, MA (US)

(72) Inventors: Maor Rahamim, Ramla (IL); Ashok Tamilarasan, Shrewsbury, MA (US); Vamsi K. Vankamamidi, Hopkinton, MA (US)

(73) Assignee: Dell Products L.P., Hopkinton, MA (US)

(21) Appl. No.: 18/901,608

(22) Filed: Sep. 30, 2024

(51) Int. Cl. G06F 9/50

(52) U.S. Cl. CPC G06F 9/5027

(57) ABSTRACT

Techniques can include: maintaining a domain cursor and instance cursors; issuing, by a thread, a resource allocation request; and performing processing to allocate a resource instance, including: determining a domain from which to allocate a resource instance, wherein the domain cursor denotes a domain identifier (ID) identifying the domain, and wherein a first of the instance cursors corresponds to the domain; performing, based on the first instance cursor, unsuccessful attempts to obtain a free resource instance of the domain, wherein the first instance cursor is advanced to a next resource ID of the domain after each of the unsuccessful attempts; determining whether the unsuccessful attempts exceeds a maximum; and responsive to determining that the unsuccessful attempts exceeds the maximum, performing second processing including: placing the thread on a queue associated with one resource instance of the domain, wherein the thread waits on the queue to acquire said one resource instance.

### BACKGROUND

Systems include different resources used by one or more host processors. The resources and the host processors in the system are interconnected by one or more communication connections, such as network connections. These resources include data storage devices such as those included in data storage systems. The data storage systems are typically coupled to one or more host processors and provide storage services to each host processor. Multiple data storage systems from one or more different vendors can be connected to provide common data storage for the one or more host processors.

A host performs a variety of data processing tasks and operations using the data storage system. For example, a host issues I/O operations, such as data read and write operations, that are subsequently received at a data storage system. The host systems store and retrieve data by issuing the I/O operations to the data storage system containing a plurality of host interface units, disk drives (or more generally storage devices), and disk interface units. The host systems access the storage devices through a plurality of channels provided therewith. The host systems provide data and access control information through the channels to a storage device of the data storage system. Data stored on the storage device is provided from the data storage system to the host systems also through the channels. The host systems do not address the storage devices of the data storage system directly, but rather, access what appears to the host systems as a plurality of files, objects, logical units, logical devices or logical volumes. Thus, the I/O operations issued by the host are directed to a particular storage entity, such as a file or logical device. The logical devices generally include physical storage provisioned from portions of one or more physical drives. Allowing multiple host systems to access the single data storage system allows the host systems to share data stored therein.

### SUMMARY:

Various embodiments of the techniques herein can include a computer-implemented method, a system and a non-transitory computer readable medium. The system can include one or more processors, and a memory comprising code that, when executed, performs the method. The non-transitory computer readable medium can include code stored thereon that, when executed, performs the method. The method can comprise: receiving K resource instances each assigned one of K resource identifiers (IDs), wherein the K resource IDs form a first range R1 of consecutive integers; partitioning the K resource instances into D domains each of size S denoting that said each domain has S resource instances, wherein the S resource instances of said each domain have corresponding resource IDs that form a subrange of consecutive integers, and wherein each of the D domains is assigned one of D domain IDs, wherein the D domain IDs from a second range R2 of consecutive integers; maintaining a domain cursor and D instance cursors, wherein the domain cursor identifies one of the D domain IDs of a next one of the D domains from which to allocate a resource instance, and wherein each of the D domains has a corresponding one of the D instance cursors denoting a resource ID of a next resource instance of said each domain from which to attempt resource instance allocation; issuing, by a first thread, a resource allocation request; and performing first processing to allocate one of the K resource instances for the resource allocation request, including: determining, in accordance with the domain cursor, a first domain from which to allocate a resource instance, wherein the domain cursor denotes a first domain ID identifying the first domain, and wherein a first instance cursor of the D instance cursors corresponds to the first domain; performing, based on the first instance cursor, a first plurality of unsuccessful attempts to obtain a resource instance of the first domain that is free, wherein each of the first plurality of unsuccessful attempts is an unsuccessful attempt to obtain a different resource instance of the first domain, wherein the first instance cursor is advanced to a next resource ID of the first domain after each of the first plurality of unsuccessful attempts; determining whether the first plurality of unsuccessful attempts exceeds a maximum; and responsive to determining that the first plurality of unsuccessful attempts exceeds the maximum, performing second processing including: placing the first thread on a first wait queue associated with one resource instance of the first domain, wherein the first thread waits on the first wait queue to acquire said one resource instance of the first domain.

In at least one embodiment, placing the first thread on the first wait queue can include adding the first thread to the first wait queue based on a FIFO (first in first out) ordering in which threads attempt to acquire said one resource instance. can The second processing include: detecting that said one resource instance is free and that the first thread is waiting in the first wait queue and is next in line to acquire said one resource instance based on the FIFO ordering; and the first thread obtaining said one resource instance in response to said resource allocation request whereby said one resource instance is allocated to the first thread. The first plurality of unsuccessful attempts can be performed with respect to first consecutive resource IDs of respective first resource instances of the first domain. Each of the first plurality of unsuccessful attempts can be a try-lock request that attempts to acquire a lock on a corresponding resource instance of the first domain that has a corresponding one of the first consecutive resource IDs.

In at least one embodiment, the try-lock request of said each unsuccessful attempt can result in third processing including: determining that the lock, on the corresponding resource instance of the first domain having the corresponding one of the first consecutive resource IDs, is taken; and responsive to determining that the lock is taken, returning false indicating that the try-lock request has failed and is unsuccessful, wherein failure to acquire the lock can indicate that the corresponding resource instance of the first domain having the corresponding one of the first consecutive resource IDs is not free and already allocated. Execution of the first thread that issued the resource allocation request may not be blocked in response to the first plurality of unsuccessful attempts. In response to each of the first plurality of unsuccessful attempts to acquire one of the first resource instances, the first thread may not wait for the one resource instance to become free. In response to a first unsuccessful attempt of the first plurality to acquire one of the first resource instances, the first thread attempts to acquire another one of the first resource instances. The lock can be an exclusive lock.

In at least one embodiment, processing can include, responsive to determining that the first plurality of unsuccessful attempts does not exceed the maximum, performing third processing including: performing, based on the first instance cursor, an additional attempt to obtain a first resource instance of the first domain, wherein the first resource instance has a first resource ID; and responsive to determining that the first resource instance of the first domain is free, allocating the first resource instance to the first thread in response to said resource allocation request.

In at least one embodiment, the first thread can be a flush thread performing processing to flush an entry of a recorded write I/O operation from a log. The K resource instances can be K pages of back-end (BE) non-volatile storage used for storing metadata (MD). The resource allocation request can be a request by the flush thread for a free one of the K pages for storing a first MD page in connection with flushing the entry for the recorded write I/O operation from the log. The recorded write I/O operation can write first content to a first logical address, and wherein the first MD page can be included in a chain of MD pages used to map the first logical address to a physical storage location of the first content as stored on BE non-volatile storage.

In at least one embodiment, the first processing can include: advancing the domain cursor from the first domain ID denoting the first domain to a second domain ID identifying a second domain that is different from the first domain; issuing, by a second thread, a second resource allocation request; and performing third processing in accordance with the domain cursor to allocate a resource instance of the second domain for the second allocation request, wherein the third processing includes commencing attempts to locate a free resource instance of the second domain based on a current resource ID of the second domain identified by a second instance cursor of the D instance cursors, wherein the second instance cursor corresponds to the second domain.

In at least one embodiment, the maximum can be equal to S.

### BRIEF DESCRIPTION OF THE DRAWINGS

Features and advantages of the present disclosure will become more apparent from the following detailed description of exemplary embodiments thereof taken in conjunction with the accompanying drawings in which:

FIG. 1 is an example of components that can be included in a system in accordance with the techniques of the present disclosure.

FIG. 2A is an example illustrating the I/O path or data path in connection with processing data in an embodiment in accordance with the techniques of the present disclosure.

FIGS. 2B, 2C and 2D are examples illustrating use of a log in at least one embodiment in accordance with the techniques of the present disclosure.

FIG. 3 is an example illustrating domains of resources instances and associated cursors in at least one embodiment in accordance with the techniques of the present disclosure.

FIGS. 4 and 5 are examples of pseudo-code of processing that can be performed in at least one embodiment in accordance with the techniques of the present disclosure.

FIGS. 6A and 6B are flowcharts of processing steps that can be performed in at least one embodiment in accordance with the techniques of the present disclosure.

### DETAILED DESCRIPTION OF EMBODIMENT(S):

A system, such as a storage system, can have one or more types or classes of resources that are generally used by consumers. For example in at least one embodiment, a thread or process of code executing on the storage system can be a consumer that consumes or uses resources, such as storage objects of the storage system. In at least one embodiment, the resources can include, for example, pages of backend (BE) non-volatile storage of the storage system used for persistently storing pages of metadata (MD).

Generally, the resource demand of the consumers can exceed the supply or amount of available resources allocated and used by the consumers. As a result, one or more of the consumers may have to wait to progress in their respective processing until the needed resources become available.

Described in the following paragraphs are techniques that can be used in connection with efficient locking and allocation of resources. In at least one embodiment, the techniques of the present disclosure can be used in a storage system in connection with an optimal locking and allocation policy of a resource allocator. In at least one embodiment, the resource allocator can allocate resources that include pages of BE non-volatile storage used for persistently storing corresponding MD pages.

Threads or processes can allocate and use pages of BE non-volatile storage that persistently store MD pages. The threads can run in parallel concurrently on the storage system. In at least one embodiment, the threads can include flush threads that flush recorded operations, such as recorded client write I/O operations, from a log. During the flush workflow performed by the flush threads, each single flush thread can allocate or consume and use multiple persistently stored MD pages.

In at least one embodiment, processing performed by a flush thread can be characterized as multi-transactional. In each transaction, the flush thread can allocate, lock and exclusively use pages of BE non-volatile storage such as for storing corresponding MD pages. When the flush thread completes a particular transaction, the flush thread can release the one or more pages allocated and used during the particular transaction. Thus in at least one embodiment, the multi-transactional flush thread can repeatedly allocate, lock, use and/or release one or more pages of non-volatile storage storing MD in each of its multiple transactions or steps. For example, assume each single flush thread performs three transactions where each of the 3 transactions includes allocating a page of non-volatile storage for storing MD, using the allocated page, and then releasing the page thereby making it available for reuse by another thread, or more generally another transaction.

In at least one embodiment, there can be more consumers than resources that are allocated and used by such consumers. Put another way, the resource demand can exceed the available resource supply. For example, there can be more flush threads in a storage system than pages of non-volatile storage consumed by the flush threads for storing MD pages. As a result, some of the flush threads have to wait for needed resources, such as pages of non-volatile storage for storing MD pages, to be available or free in order for such flush threads to continue their respective processing that consumes such resources. In at least one embodiment, since flush threads are multi-transactional, and some transactions are independently performed, it can be desirable to allow the number executing threads to exceed the resource demand of the number of threads where one or more of the executing threads can wait for needed resources while the executing threads progress in parallel.

In at least one embodiment, resources can be efficiently allocated in a balanced manner. For example, assume there are K resource instances in a system where K denotes the number of pages of BE non-volatile storage available for storing MD. In at least one embodiment, the techniques of the present disclosure can provide for allocating the K resource instances in a balanced manner. For example, assume that there are M allocations of the K instances over time. In at least one embodiment, the techniques of the present disclosure provide for generally allocating and reusing each of the K instances on average approximately (e.g., within some specified tolerance or variation) M/K times.

In at least one embodiment, the resources, such as the pages of BE non-volatile storage, can be managed by a first component and allocated by a separate second component. For example in at least one embodiment, K instances or pages of BE non-volatile storage can be managed by a caching layer or cache component. In order for the resource allocator to determine whether a particular page or instance of non-volatile storage is free or available for storing MD, the resource allocator may have to query the cache component. For example, each of the K instances or pages can be identified by a unique corresponding resource identifier (ID) (sometimes also referred to as a resource ID or an instance ID). In order for the resource allocator to determine whether a particular page J is free or available for allocation, the resource allocator can issue a request to the cache component as whether page J is free. The desired resource, page J, can also be locked through the cache component. As such in at least one embodiment, the resource allocator can be characterized as blind in that the resource allocator may not track which resource instances are free whereby making such a determination as to whether a resource instance is free can be made through queries or probes to the cache component. Thus in at least one embodiment, resource allocation and locking, such as where resources are pages of BE non-volatile storage managed by the cache component, can be expensive operations.

In at least one embodiment consistent with the foregoing: i) resource demand by executing threads can exceed the resource supply available to the executing threads, ii) resources can be allocated in a balanced manner, and iii) resource allocation can be blind in that the allocator determines whether a particular resource instance is free through querying another component that manages the resources.

One naïve solution to perform resource allocation can generally perform round-robin (RR) selection over the range of K resource instances while trying or attempting to lock a corresponding one of the K instances. If the lock request is denied because the instance is in use/allocated (e.g., not free or available), then processing can proceed to request the lock of the next resource instance. The foregoing can be repeatedly performed by continually traversing or looping across the K resource instances until an available unlocked (and thus unallocated) instance is located. The foregoing can be performed without causing the requesting thread to block or wait whereby processing can continually loop in a form of busy waiting until an available free unlocked resource instance is located. One drawback of the foregoing solution or approach is the non-deterministic aspect in that there is no guarantee when, or even if, the allocation will succeed thereby making the waiting time to obtain a free resource instance unpredictable. In this manner, the amount of time that a consumer, such as a thread, waits for a requested resource to be allocated can be characterized as unbounded. A second drawback is due to the undesirable amount of CPU and cache component resources that can be consumed. For example, there is generally no bound on the amount of CPU time consumed in connection with continually looping through the K instances to locate a free instance. As a result, an undesirable excessive amount of CPU time can be consumed by the foregoing processing.

Accordingly, the techniques of the present disclosure described in the following paragraphs overcome at least the foregoing drawbacks. In at least one embodiment, the techniques of the present disclosure apply an optimized RR approach. In at least one embodiment, the techniques of the present disclosure can be characterized as utilizing a nested or multi-level RR approach when selecting a particular resource instance having a particular resource ID in connection with a balanced resource allocation approach and in connection with distributing any waiting threads waiting for a free unlocked resource instance. In at least one embodiment, processing can obtain a free resource instance that is i) available for allocation and ii) has a corresponding resource ID. In at least one embodiment, such processing can attempt to locate a free resource instance with a resource ID by attempting to acquire a corresponding lock on the resource instance using a try-lock request.

The try-lock semantics can attempt to acquire the lock of a particular resource instance having a particular resource ID. The lock can be an exclusive lock where the requester is requesting exclusive access to the particular resource. With the try-lock, if the particular resource with the resource ID is free (e.g., its lock is free or available or not held by another thread), then processing proceeds to acquire the lock on the particular resource and thereby obtain the resource for the requesting thread. If the particular resource with the resource ID is otherwise not free, the lock request of the requesting thread is denied. With a try-lock request to obtain a lock, the requesting thread does not block or wait until the requested lock is available. Rather the lock request fails and processing can continue by issuing another try-lock request for a different resource ID of another resource instance. In at least one embodiment, the techniques of the disclosure can limit the maximum (MAX) number of times that try-lock requests are performed to obtain a lock and thus obtain a free resource instance. In at least one embodiment, if MAX attempts to acquire a free resource instance using the try-lock result in failure to obtain a free resource instance, processing can then fallback to a hard-lock. In at least one embodiment, the hard-lock can block further execution progress of a requesting thread if the requested lock is currently unavailable or not free. Put another way in at least one embodiment with the hard-lock, the requesting thread waits or is blocked in its further workflow progress until the requesting thread acquires the requested lock. With the hard-lock in at least one embodiment, the requesting thread can wait on a wait queue associated with a corresponding particular one of the resource instances. When the particular resource instance associated with the wait queue becomes free, one of the waiting threads on the wait queue is the next thread to obtain the lock and thus obtain the particular resource instance. When a particular thread acquires or holds a lock on a particular resource instance, the resource instance has been allocated to the particular thread holding the corresponding lock. Thus each waiting thread can be placed in the wait queue to await its corresponding turn to acquire the lock on the corresponding resource instance.

In at least one embodiment, the wait queue associated with a particular resource instance can be a FIFO (first in first out) queue of threads waiting to acquire or be allocated the corresponding particular resource instance. Threads can be placed on the wait queue in a FIFO order corresponding to the order in which the threads attempt to acquire the lock on the corresponding resource instance. In this manner, the resource instance can be allocated to waiting threads on the wait queue based on the FIFO order in which the threads requested or attempted to acquire the resource instance. Put another way, threads can obtain or be granted the lock on the resource instance in the FIFO order in which the threads attempted to acquire the lock on the resource instance. When the resource instance associated with the wait queue is freed or released, the next waiting thread on the FIFO wait queue is granted the lock on the corresponding resource (and is thus allocated the corresponding resource). In at least one embodiment, threads can be removed from the head or front of the FIFO wait queue, and threads can be added to the tail or end of the FIFO wait queue. Thus a thread attempting to access a locked resource can be added to the wait queue by placing the thread at the tail or end of the FIFO wait queue. Threads can be granted the lock (and thus allocated the resource instance) from the front or head of the FIFO wait queue. Thus in at least one embodiment, i) a first thread at the head or front of the FIFO wait queue has been waiting the longest amount of time to acquire the corresponding resource instance with respect to all waiting threads in the FIFO wait queue; and ii) a second thread at the tail or end of the FIFO wait queue has been waiting the shortest or least amount of time to acquire the corresponding resource instance with respect to all waiting threads in the FIFO wait queue. Thus threads waiting in the wait queue in the FIFO order can acquire the lock, and thus be allocated the corresponding resource instance, based on the FIFO order. For example, there can be a first waiting thread TH1 that has been waiting a first amount of time (AMT1) in the wait queue, and there can be a second waiting thread TH2 that has been waiting a second amount of time (AMT2) in the wait queue. If AMT1 < AMT2, then TH1 acquires the lock and is therefore allocated corresponding resource instance before TH2. Thus waiting threads of the wait queue can acquire the lock and be accordingly allocated corresponding resource instance in an order based on increasing amount of times the corresponding threads wait in the wait queue. Any new thread attempting to acquire and be allocated the resource instance while the resource instance has a wait queue can be placed on the wait queue in FIFO order.

Thus in at least one embodiment, use of the hard-lock resulting in blocking further execution of waiting threads can provide a predictable FIFO ordering for lock granting to waiting threads.

In at least one embodiment, the techniques of the present disclosure provide for partitioning K resource instances into D domains each of size S. The K resource instances can be identified by corresponding resource instance IDs forming a range of consecutive integers. Each of the D domains can include S resource instances having corresponding resource instance IDs forming a subrange of consecutive integers. The D domains can each be uniquely identified by a corresponding domain index. In at least one embodiment, the domain indices across all D domains can form a second range of consecutive integers. Processing to service resource allocation requests and locate a free resource instance for allocation can traverse the D domains of the K resources instances using a two level round robin approach. A domain cursor and a set of D domain instance cursors can be maintained. The domain cursor can traverse sequentially, in a RR manner, over the domain indices of the D domains and then restart the traversal in a cyclic manner. A domain instance cursor can be maintained for each of the D domains, where the domain instance cursor for a corresponding domain can be used to traverse, in a RR manner, over the resource instance IDs of the resource instances of the corresponding domain. In at least one embodiment, the domain cursor can be advanced in a RR manner to a next domain index with each new resource allocation request. Thus at a first level, the domain cursor provides for performing a RR traversal across the D domains such that each new resource allocation request can commence with attempting to locate a free resource instance in a next one of the D domains. The current domain can refer to a domain index uniquely identifying one of the D domains at a point in time for a new resource allocation request. In response to receiving the new resource allocation request, the current domain can be assigned the current domain index of the domain cursor. Thus the current domain can identify the particular domain to be searched for a free resource instance for the current allocation request. The domain instance cursor of the current domain can be used to traverse, in a RR manner, the current domain in attempting to locate a free resource instance to satisfy the current allocation request. Thus at a second level, the domain instance cursors can be used in performing RR traversals of respective domains of resource instances.

In at least one embodiment, MAX (the maximum number of try-lock attempts allowed to locate a free resource instance) can be equal to S (the size or number of resource instances in each of the D domains). In such an embodiment where MAX=S, searching for a free resource instance to allocate in response to a resource allocation request can result in searching for the free resource instance within a single one of the D domains. Furthermore, the foregoing searching can be bounded in that at most MAX try-lock attempts are performed while traversing through the resource instances of the single domain in a RR manner using the single domain’s resource instance cursor. In at least one embodiment, if all MAX try-lock attempts fail to locate a free (e.g., unlocked) unallocated resource instance, then a hard-lock and associated processing can be utilized. In at least one embodiment in connection with the hard-lock, the thread that issued the current request allocation can wait on a corresponding wait queue of a resource instance. In at least one embodiment, the wait queue can be associated with a resource instance having a corresponding resource instance ID denoted by the current domain and its respective domain instance cursor. Thus in at least one embodiment, a resource instance can be allocated by performing at most MAX try-lock allocation attempts. If the MAX try-lock allocation attempts failed to locate an unlocked and thus free resource instance, processing can then allocate a free resource instance using a hard-lock allocation whereby the requesting thread can wait on a wait queue for a corresponding resource instance to become free or available for allocation to the requesting thread.

The foregoing and other aspects of the techniques of the present disclosure are described in more detail in the following paragraphs.

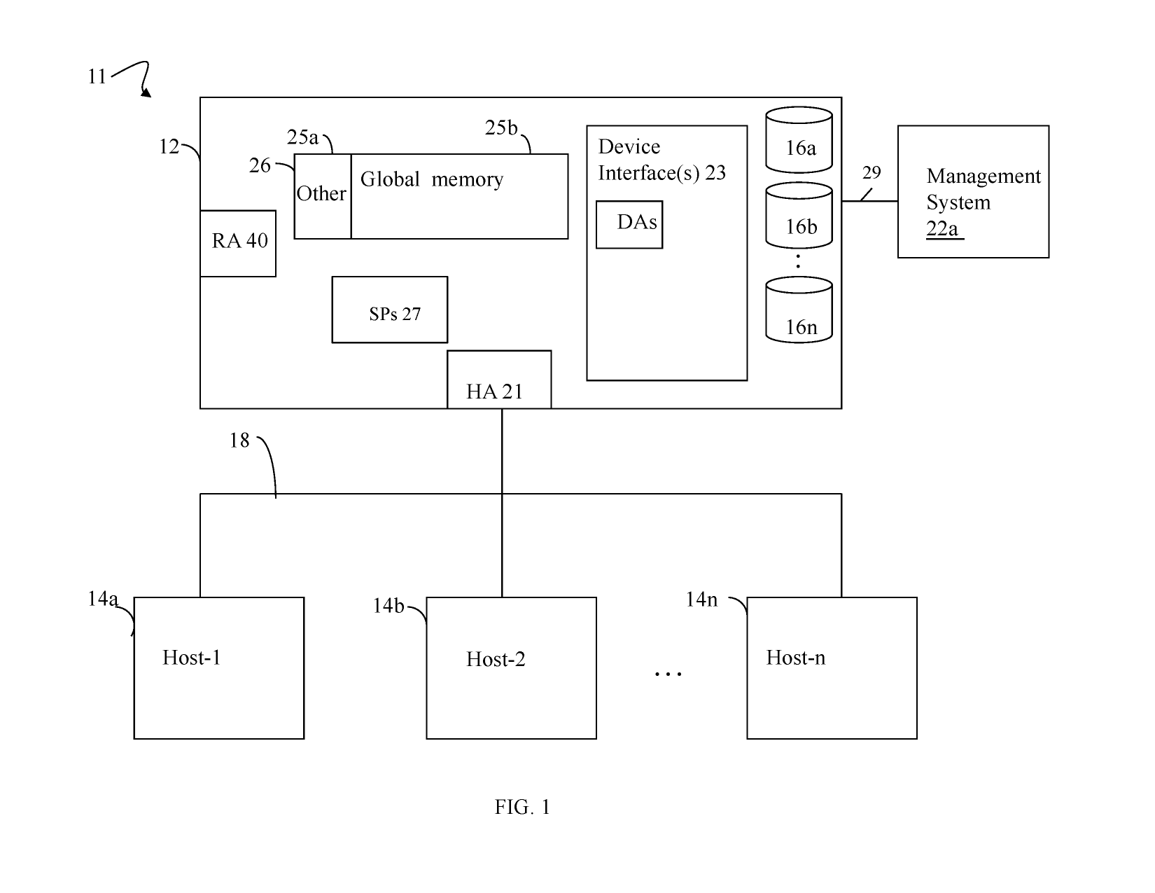

Referring to the FIG. 1, shown is an example of an embodiment of a system 11 that can be used in connection with performing the techniques described herein. The system 11 includes a data storage system 12 connected to the host systems (also sometimes referred to as hosts) 14a-14n through the communication medium 18. In this embodiment of the system 11, the n hosts 14a-14n can access the data storage system 12, for example, in performing input/output (I/O) operations or data requests. The communication medium 18 can be any one or more of a variety of networks or other type of communication connections as known to those skilled in the art. The communication medium 18 can be a network connection, bus, and/or other type of data link, such as a hardwire or other connections known in the art. For example, the communication medium 18 can be the Internet, an intranet, network (including a Storage Area Network (SAN)) or other wireless or other hardwired connection(s) by which the host systems 14a-14n can access and communicate with the data storage system 12, and can also communicate with other components included in the system 11.

Each of the host systems 14a-14n and the data storage system 12 included in the system 11 are connected to the communication medium 18 by any one of a variety of connections in accordance with the type of communication medium 18. The processors included in the host systems 14a-14n and data storage system 12 can be any one of a variety of proprietary or commercially available single or multi-processor system, such as an Intel-based processor, or other type of commercially available processor able to support traffic in accordance with each particular embodiment and application.

It should be noted that the particular examples of the hardware and software that can be included in the data storage system 12 are described herein in more detail, and can vary with each particular embodiment. Each of the hosts 14a-14n and the data storage system 12 can all be located at the same physical site, or, alternatively, can also be located in different physical locations. The communication medium 18 used for communication between the host systems 14a-14n and the data storage system 12 of the system 11 can use a variety of different communication protocols such as block-based protocols (e.g., SCSI (Small Computer System Interface), Fibre Channel (FC), iSCSI), file system-based protocols (e.g., NFS or network file server), and the like. Some or all of the connections by which the hosts 14a-14n and the data storage system 12 are connected to the communication medium 18 can pass through other communication devices, such as switching equipment, a phone line, a repeater, a multiplexer or even a satellite.

Each of the host systems 14a-14n can perform data operations. In the embodiment of the FIG. 1, any one of the host computers 14a-14n can issue a data request to the data storage system 12 to perform a data operation. For example, an application executing on one of the host computers 14a-14n can perform a read or write operation resulting in one or more data requests to the data storage system 12.

It should be noted that although the element 12 is illustrated as a single data storage system, such as a single data storage array, the element 12 can also represent, for example, multiple data storage arrays alone, or in combination with, other data storage devices, systems, appliances, and/or components having suitable connectivity, such as in a SAN (storage area network) or LAN (local area network), in an embodiment using the techniques herein. It should also be noted that an embodiment can include data storage arrays or other components from one or more vendors. In subsequent examples illustrating the techniques herein, reference can be made to a single data storage array by a vendor. However, as will be appreciated by those skilled in the art, the techniques herein are applicable for use with other data storage arrays by other vendors and with other components than as described herein for purposes of example.

The data storage system 12 can be a data storage appliance or a data storage array including a plurality of data storage devices (PDs) 16a-16n. The data storage devices 16a-16n can include one or more types of data storage devices such as, for example, one or more rotating disk drives and/or one or more solid state drives (SSDs). An SSD is a data storage device that uses solid-state memory to store persistent data. SSDs refer to solid state electronics devices as distinguished from electromechanical devices, such as hard drives, having moving parts. Flash devices or flash memory-based SSDs are one type of SSD that contain no moving mechanical parts. The flash devices can be constructed using nonvolatile semiconductor NAND flash memory. The flash devices can include, for example, one or more SLC (single level cell) devices and/or MLC (multi level cell) devices.

The data storage array can also include different types of controllers, adapters or directors, such as an HA 21 (host adapter), RA 40 (remote adapter), and/or device interface(s) 23. Each of the adapters (sometimes also known as controllers, directors or interface components) can be implemented using hardware including a processor with a local memory with code stored thereon for execution in connection with performing different operations. The HAs can be used to manage communications and data operations between one or more host systems and the global memory (GM). In an embodiment, the HA can be a Fibre Channel Adapter (FA) or other adapter which facilitates host communication. The HA 21 can be characterized as a front end component of the data storage system which receives a request from one of the hosts 14a-n. The data storage array can include one or more RAs used, for example, to facilitate communications between data storage arrays. The data storage array can also include one or more device interfaces 23 for facilitating data transfers to/from the data storage devices 16a-16n. The data storage device interfaces 23 can include device interface modules, for example, one or more disk adapters (DAs) (e.g., disk controllers) for interfacing with the flash drives or other physical storage devices (e.g., PDS 16a-n). The DAs can also be characterized as back end components of the data storage system which interface with the physical data storage devices.

One or more internal logical communication paths can exist between the device interfaces 23, the RAs 40, the HAs 21, and the memory 26. An embodiment, for example, can use one or more internal busses and/or communication modules. For example, the global memory portion 25b can be used to facilitate data transfers and other communications between the device interfaces, the HAs and/or the RAs in a data storage array. In one embodiment, the device interfaces 23 can perform data operations using a system cache included in the global memory 25b, for example, when communicating with other device interfaces and other components of the data storage array. The other portion 25a is that portion of the memory that can be used in connection with other designations that can vary in accordance with each embodiment.

The particular data storage system as described in this embodiment, or a particular device thereof, such as a disk or particular aspects of a flash device, should not be construed as a limitation. Other types of commercially available data storage systems, as well as processors and hardware controlling access to these particular devices, can also be included in an embodiment.

The host systems 14a-14n provide data and access control information through channels to the storage systems 12, and the storage systems 12 also provide data to the host systems 14a-n through the channels. The host systems 14a-n do not address the drives or devices 16a-16n of the storage systems directly, but rather access to data can be provided to one or more host systems from what the host systems view as a plurality of logical devices, logical volumes (LVs) which are sometimes referred to herein as logical units (e.g., LUNs). A logical unit (LUN) can be characterized as a disk array or data storage system reference to an amount of storage space that has been formatted and allocated for use to one or more hosts. A logical unit can have a logical unit number that is an I/O address for the logical unit. As used herein, a LUN or LUNs can refer to the different logical units of storage which can be referenced by such logical unit numbers. In some embodiments, at least some of the LUNs do not correspond to the actual or physical disk drives or more generally physical storage devices. For example, one or more LUNs can reside on a single physical disk drive, data of a single LUN can reside on multiple different physical devices, and the like. Data in a single data storage system, such as a single data storage array, can be accessed by multiple hosts allowing the hosts to share the data residing therein. The HAs can be used in connection with communications between a data storage array and a host system. The RAs can be used in facilitating communications between two data storage arrays. The DAs can include one or more type of device interface used in connection with facilitating data transfers to/from the associated disk drive(s) and LUN (s) residing thereon. For example, such device interfaces can include a device interface used in connection with facilitating data transfers to/from the associated flash devices and LUN(s) residing thereon. It should be noted that an embodiment can use the same or a different device interface for one or more different types of devices than as described herein.

In an embodiment in accordance with the techniques herein, the data storage system can be characterized as having one or more logical mapping layers in which a logical device of the data storage system is exposed to the host whereby the logical device is mapped by such mapping layers of the data storage system to one or more physical devices. Additionally, the host can also have one or more additional mapping layers so that, for example, a host side logical device or volume is mapped to one or more data storage system logical devices as presented to the host.

It should be noted that although examples of the techniques herein can be made with respect to a physical data storage system and its physical components (e.g., physical hardware for each HA, DA, HA port and the like), the techniques herein can be performed in a physical data storage system including one or more emulated or virtualized components (e.g., emulated or virtualized ports, emulated or virtualized DAs or HAs), and also a virtualized or emulated data storage system including virtualized or emulated components.

Also shown in the FIG. 1 is a management system 22a that can be used to manage and monitor the data storage system 12. In one embodiment, the management system 22a can be a computer system which includes data storage system management software or application that executes in a web browser. A data storage system manager can, for example, view information about a current data storage configuration such as LUNs, storage pools, and the like, on a user interface (UI) in a display device of the management system 22a. Alternatively, and more generally, the management software can execute on any suitable processor in any suitable system. For example, the data storage system management software can execute on a processor of the data storage system 12.

Information regarding the data storage system configuration can be stored in any suitable data container, such as a database. The data storage system configuration information stored in the database can generally describe the various physical and logical entities in the current data storage system configuration. The data storage system configuration information can describe, for example, the LUNs configured in the system, properties and status information of the configured LUNs (e.g., LUN storage capacity, unused or available storage capacity of a LUN, consumed or used capacity of a LUN), configured RAID groups, properties and status information of the configured RAID groups (e.g., the RAID level of a RAID group, the particular PDs that are members of the configured RAID group), the PDs in the system, properties and status information about the PDs in the system, local replication configurations and details of existing local replicas (e.g., a schedule of when a snapshot is taken of one or more LUNs, identify information regarding existing snapshots for a particular LUN), remote replication configurations (e.g., for a particular LUN on the local data storage system, identify the LUN’s corresponding remote counterpart LUN and the remote data storage system on which the remote LUN is located), data storage system performance information such as regarding various storage objects and other entities in the system, and the like.

It should be noted that each of the different controllers or adapters, such as each HA, DA, RA, and the like, can be implemented as a hardware component including, for example, one or more processors, one or more forms of memory, and the like. Code can be stored in one or more of the memories of the component for performing processing.

The device interface, such as a DA, performs I/O operations on a physical device or drive 16a-16n. In the following description, data residing on a LUN can be accessed by the device interface following a data request in connection with I/O operations. For example, a host can issue an I/O operation which is received by the HA 21. The I/O operation can identify a target location from which data is read from, or written to, depending on whether the I/O operation is, respectively, a read or a write operation request. The target location of the received I/O operation can include a logical address expressed in terms of a LUN and logical offset or location (e.g., LBA or logical block address) on the LUN. Processing can be performed on the data storage system to further map the target location of the received I/O operation, expressed in terms of a LUN and logical offset or location on the LUN, to its corresponding physical storage device (PD) and address or location on the PD. The DA which services the particular PD can further perform processing to either read data from, or write data to, the corresponding physical device location for the I/O operation.

In at least one embodiment, a logical address LA1, such as expressed using a logical device or LUN and LBA, can be mapped on the data storage system to a physical address or location PA1, where the physical address or location PA1 contains the content or data stored at the corresponding logical address LA1. Generally, mapping information or a mapper layer can be used to map the logical address LA1 to its corresponding physical address or location PA1 containing the content stored at the logical address LA1. In some embodiments, the mapping information or mapper layer of the data storage system used to map logical addresses to physical addresses can be characterized as metadata managed by the data storage system. In at least one embodiment, the mapping information or mapper layer can be a hierarchical arrangement of multiple mapper layers. Mapping LA1 to PA1 using the mapper layer can include traversing a chain of metadata pages in different mapping layers of the hierarchy, where a page in the chain can reference a next page, if any, in the chain. In some embodiments, the hierarchy of mapping layers can form a tree-like structure with the chain of metadata pages denoting a path in the hierarchy from a root or top level page to a leaf or bottom level page.

In at least one embodiment, reading contents stored at a logical address LA1 such as to service a read I/O in response to a read cache miss can including traversing the mapping information of the chain of metadata pages mapping the logical address to a physical location or address of the content of LA1 as stored in BE non-volatile storage.

In at least one embodiment, a write I/O that writes content C1 to LA1 can be persistently recorded, such as in a log discussed elsewhere herein, and then an acknowledgement can be returned to the issuing client. Subsequently, the recorded write I/O can be flushed from the log. Flushing the recorded write I/O can include storing C1 at a physical location or address, and then creating and/or updating corresponding mapping information that maps LA1 the physical location of C1.

It should be noted that an embodiment of a data storage system can include components having different names from that described herein but which perform functions similar to components as described herein. Additionally, components within a single data storage system, and also between data storage systems, can communicate using any suitable technique that can differ from that as described herein for exemplary purposes. For example, element 12 of the FIG. 1 can be a data storage system, such as a data storage array, that includes multiple storage processors (SPs). Each of the SPs 27 can be a CPU including one or more “cores” or processors and each having their own memory used for communication between the different front end and back end components rather than utilize a global memory accessible to all storage processors. In such embodiments, the memory 26 can represent memory of each such storage processor.

Generally, the techniques herein can be used in connection with any suitable storage system, appliance, device, and the like, in which data is stored. For example, an embodiment can implement the techniques herein using a midrange data storage system as well as a high end or enterprise data storage system.

The data path or I/O path can be characterized as the path or flow of I/O data through a system. For example, the data or I/O path can be the logical flow through hardware and software components or layers in connection with a user, such as an application executing on a host (e.g., more generally, a data storage client) issuing I/O commands (e.g., SCSI-based commands, and/or file-based commands) that read and/or write user data to a data storage system, and also receive a response (possibly including requested data) in connection such I/O commands.

The control path, also sometimes referred to as the management path, can be characterized as the path or flow of data management or control commands through a system. For example, the control or management path can be the logical flow through hardware and software components or layers in connection with issuing data storage management command to and/or from a data storage system, and also receiving responses (possibly including requested data) to such control or management commands. For example, with reference to the FIG. 1, the control commands can be issued from data storage management software executing on the management system 22a to the data storage system 12. Such commands can be, for example, to establish or modify data services, provision storage, perform user account management, and the like.

The data path and control path define two sets of different logical flow paths. In at least some of the data storage system configurations, at least part of the hardware and network connections used for each of the data path and control path can differ. For example, although both control path and data path can generally use a network for communications, some of the hardware and software used can differ. For example, with reference to the FIG. 1, a data storage system can have a separate physical connection 29 from a management system 22a to the data storage system 12 being managed whereby control commands can be issued over such a physical connection 29. However in at least one embodiment, user I/O commands are never issued over such a physical connection 29 provided solely for purposes of connecting the management system to the data storage system. In any case, the data path and control path each define two separate logical flow paths.

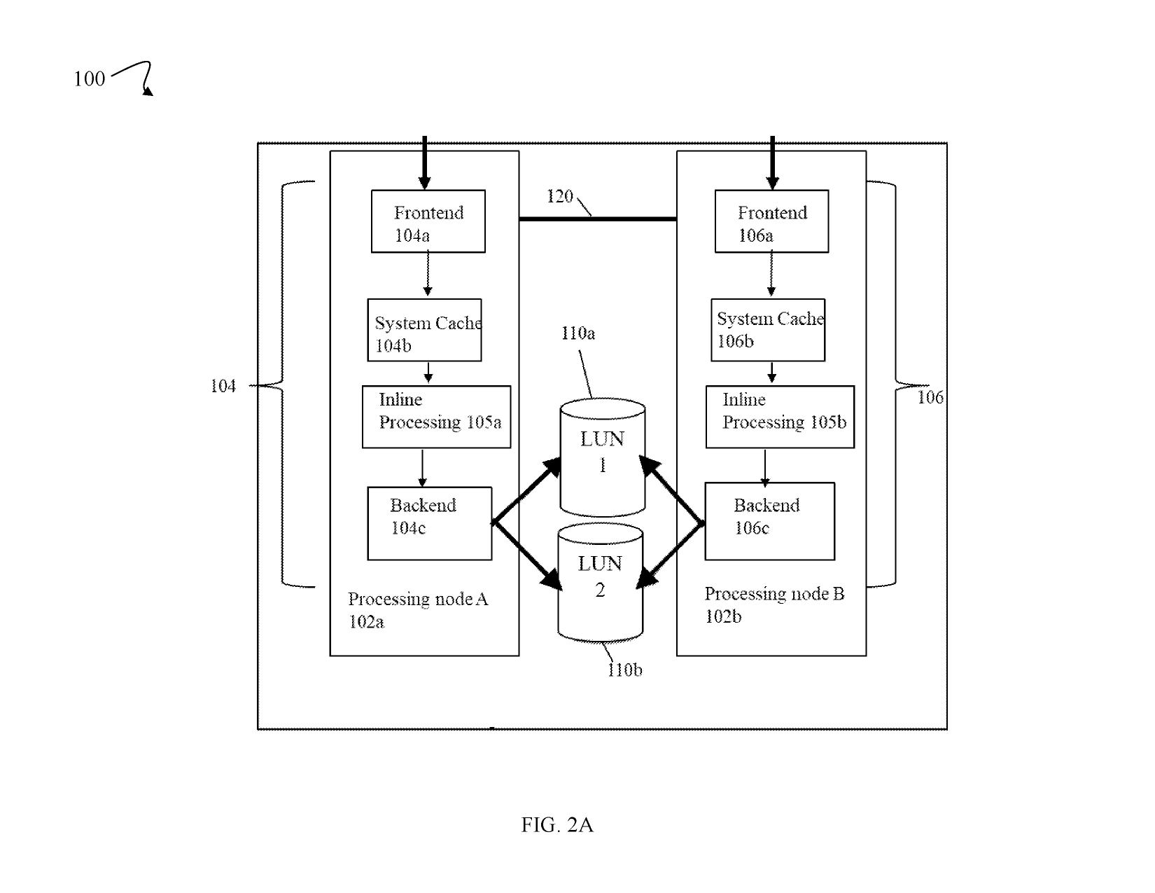

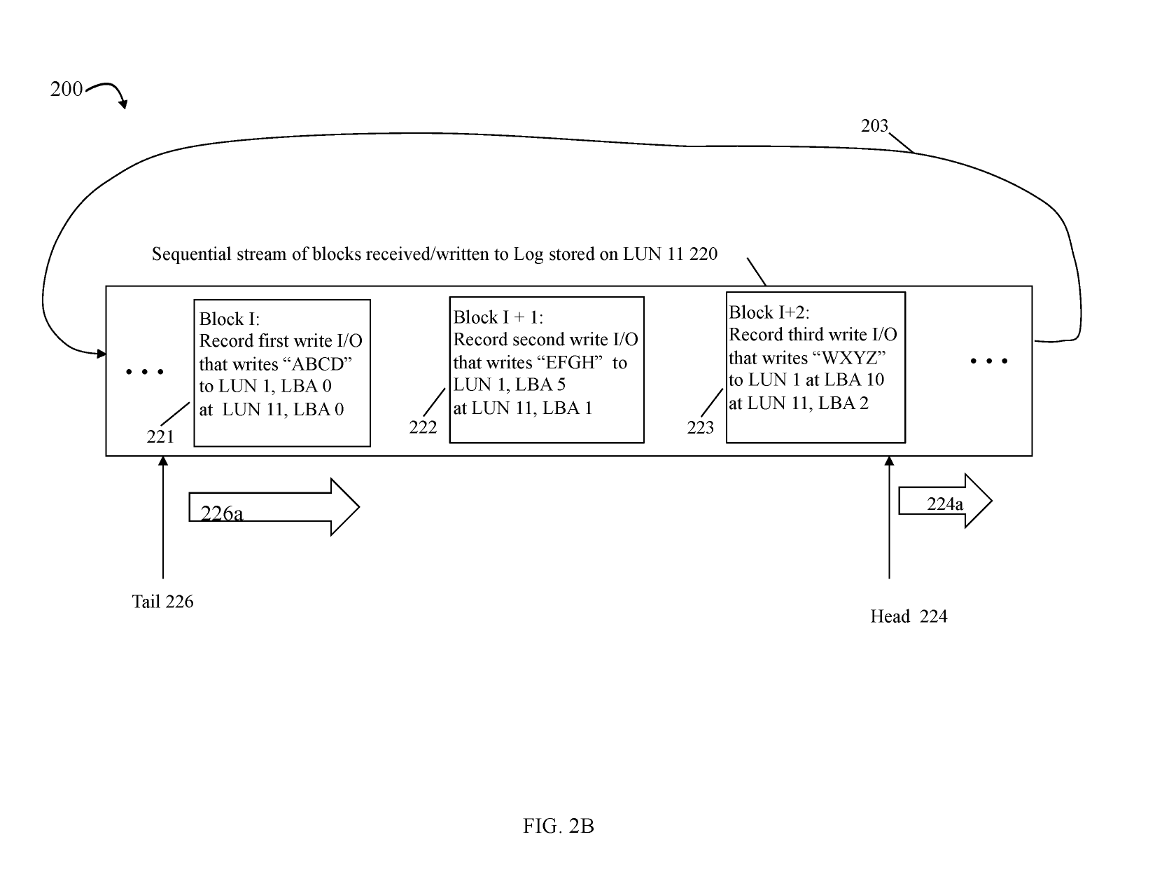

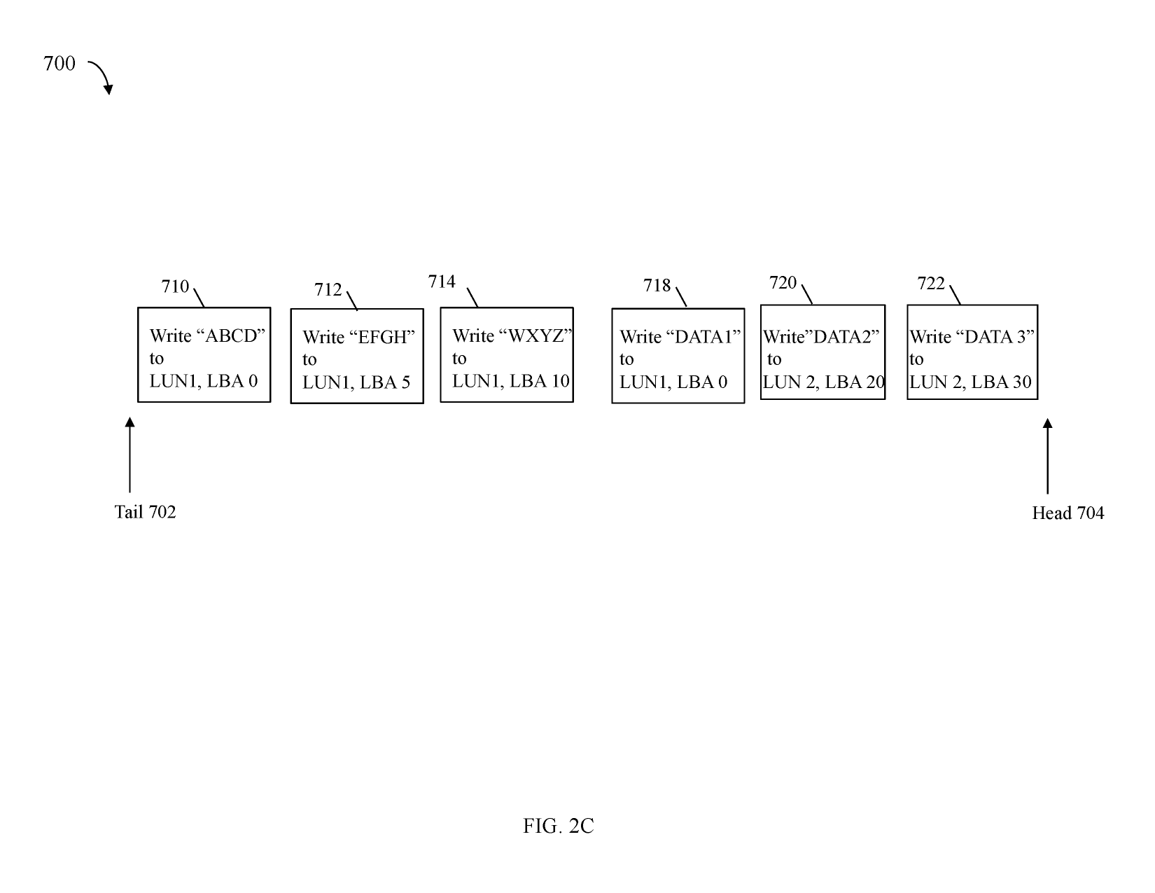

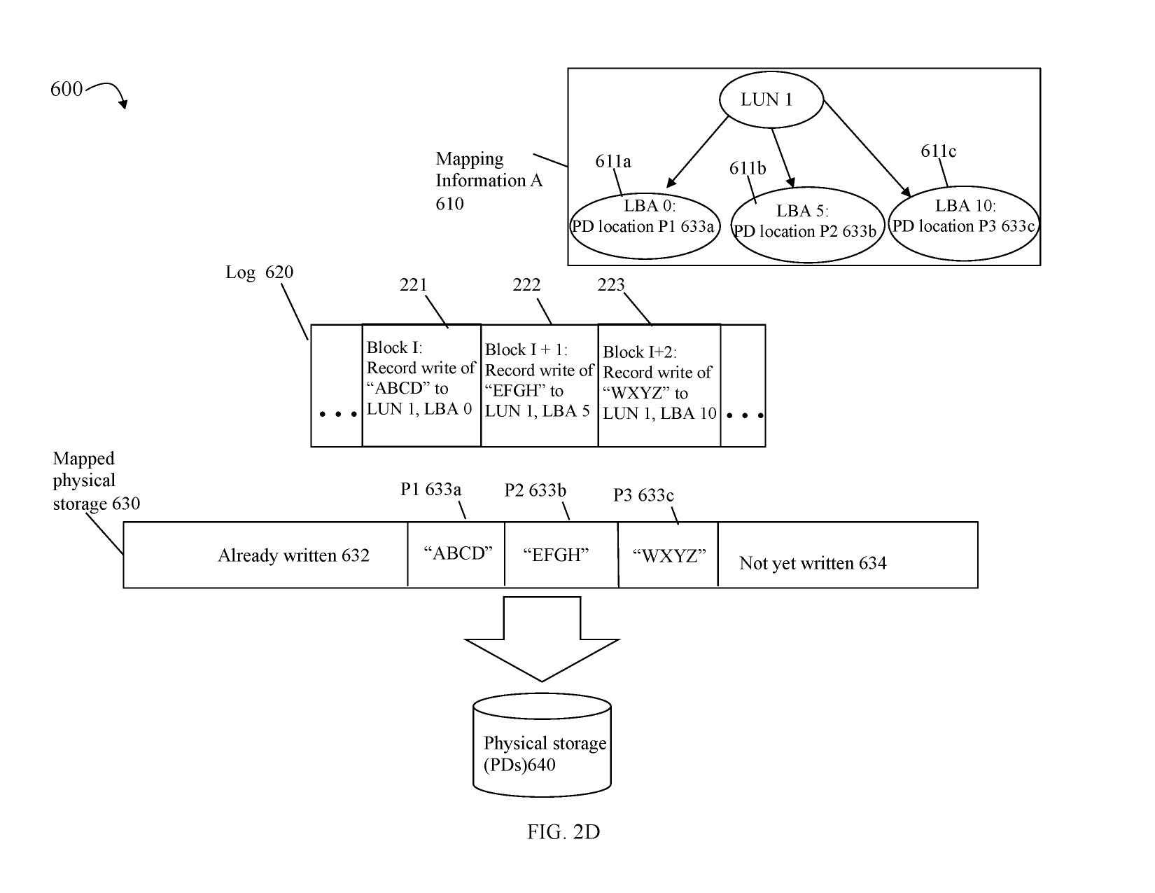

With reference to the FIG. 2A, shown is an example 100 illustrating components that can be included in the data path in at least one existing data storage system in accordance with the techniques herein. The example 100 includes two processing nodes A 102a and B 102b and the associated software stacks 104, 106 of the data path, where I/O requests can be received by either processing node 102a or 102b. In the example 200, the data path 104 of processing node A 102a includes: the frontend (FE) component 104a (e.g., an FA or front end adapter) that translates the protocol-specific request into a storage system-specific request; a system cache layer 104b where data is temporarily stored; an inline processing layer 105a; and a backend (BE) component 104c that facilitates movement of the data between the system cache and non-volatile physical storage (e.g., back end physical non-volatile storage devices or PDs accessed by BE components such as DAs as described herein). During movement of data in and out of the system cache layer 104b (e.g., such as in connection with read data from, and writing data to, physical storage 110a, 110b), inline processing can be performed by layer 105a. Such inline processing operations of 105a can be optionally performed and can include any one of more data processing operations in connection with data that is flushed from system cache layer 104b to the back-end non-volatile physical storage 110a, 110b, as well as when retrieving data from the back-end non-volatile physical storage 110a, 110b to be stored in the system cache layer 104b. In at least one embodiment, the inline processing can include, for example, performing one or more data reduction operations such as data deduplication or data compression. The inline processing can include performing any suitable or desirable data processing operations as part of the I/O or data path.

In a manner similar to that as described for data path 104, the data path 106 for processing node B 102b has its own FE component 106a, system cache layer 106b, inline processing layer 105b, and BE component 106c that are respectively similar to the components 104a, 104b, 105a and 104c. The elements 110a, 110b denote the non-volatile BE physical storage provisioned from PDs for the LUNs, whereby an I/O can be directed to a location or logical address of a LUN and where data can be read from, or written to, the logical address. The LUNs 110a, 110b are examples of storage objects representing logical storage entities included in an existing data storage system configuration. Since, in this example, writes directed to the LUNs 110a, 110b can be received for processing by either of the nodes 102a and 102b, the example 100 illustrates what is also referred to as an active-active configuration.

In connection with a write operation received from a host and processed by the processing node A 102a, the write data can be written to the system cache 104b, marked as write pending (WP) denoting it needs to be written to the physical storage 110a, 110b and, at a later point in time, the write data can be destaged or flushed from the system cache to the physical storage 110a, 110b by the BE component 104c. The write request can be considered complete once the write data has been stored in the system cache whereby an acknowledgement regarding the completion can be returned to the host (e.g., by component the 104a). At various points in time, the WP data stored in the system cache is flushed or written out to the physical storage 110a, 110b.

In connection with the inline processing layer 105a, prior to storing the original data on the physical storage 110a, 110b, one or more data reduction operations can be performed. For example, the inline processing can include performing data compression processing, data deduplication processing, and the like, that can convert the original data (as stored in the system cache prior to inline processing) to a resulting representation or form which is then written to the physical storage 110a, 110b.

In connection with a read operation to read a block of data, a determination is made as to whether the requested read data block is stored in its original form (in system cache 104b or on physical storage 110a, 110b), or whether the requested read data block is stored in a different modified form or representation. If the requested read data block (which is stored in its original form) is in the system cache, the read data block is retrieved from the system cache 104b and returned to the host. Otherwise, if the requested read data block is not in the system cache 104b but is stored on the physical storage 110a, 110b in its original form, the requested data block is read by the BE component 104c from the backend storage 110a, 110b, stored in the system cache and then returned to the host.

If the requested read data block is not stored in its original form, the original form of the read data block is recreated and stored in the system cache in its original form so that it can be returned to the host. Thus, requested read data stored on physical storage 110a, 110b can be stored in a modified form where processing is performed by 105a to restore or convert the modified form of the data to its original data form prior to returning the requested read data to the host.

Also illustrated in FIG. 2A is an internal network interconnect 120 between the nodes 102a, 102b. In at least one embodiment, the interconnect 120 can be used for internode communication between the nodes 102a, 102b.

In connection with at least one embodiment in accordance with the techniques herein, each processor or CPU can include its own private dedicated CPU cache (also sometimes referred to as processor cache) that is not shared with other processors. In at least one embodiment, the CPU cache, as in general with cache memory, can be a form of fast memory (relatively faster than main memory which can be a form of RAM). In at least one embodiment, the CPU or processor cache is on the same die or chip as the processor and typically, like cache memory in general, is far more expensive to produce than normal RAM which can used as main memory. The processor cache can be substantially faster than the system RAM such as used as main memory and contains information that the processor will be immediately and repeatedly accessing. The faster memory of the CPU cache can, for example, run at a refresh rate that's closer to the CPU's clock speed, which minimizes wasted cycles. In at least one embodiment, there can be two or more levels (e.g., L1, L2 and L3) of cache. The CPU or processor cache can include at least an L1 level cache that is the local or private CPU cache dedicated for use only by that particular processor. The two or more levels of cache in a system can also include at least one other level of cache (LLC or lower level cache) that is shared among the different CPUs. The L1 level cache serving as the dedicated CPU cache of a processor can be the closest of all cache levels (e.g., L1-L3) to the processor which stores copies of the data from frequently used main memory locations. Thus, the system cache as described herein can include the CPU cache (e.g., the L1 level cache or dedicated private CPU/processor cache) as well as other cache levels (e.g., the LLC) as described herein. Portions of the LLC can be used, for example, to initially cache write data which is then flushed to the backend physical storage such as BE PDs providing non-volatile storage. For example, in at least one embodiment, a RAM based memory can be one of the caching layers used as to cache the write data that is then flushed to the backend physical storage. When the processor performs processing, such as in connection with the inline processing 105a, 105b as noted above, data can be loaded from the main memory and/or other lower cache levels into its CPU cache.

In at least one embodiment, the data storage system can be configured to include one or more pairs of nodes, where each pair of nodes can be described and represented as the nodes 102a-b in the FIG. 2. For example, a data storage system can be configured to include at least one pair of nodes and at most a maximum number of node pairs, such as for example, a maximum of 4 node pairs. The maximum number of node pairs can vary with embodiment. In at least one embodiment, a base enclosure can include the minimum single pair of nodes and up to a specified maximum number of PDs. In some embodiments, a single base enclosure can be scaled up to have additional BE non-volatile storage using one or more expansion enclosures, where each expansion enclosure can include a number of additional PDs. Further, in some embodiments, multiple base enclosures can be grouped together in a load-balancing cluster to provide up to the maximum number of node pairs. Consistent with other discussion herein, each node can include one or more processors and memory. In at least one embodiment, each node can include two multi-core processors with each processor of the node having a core count of between 8 and 28 cores. In at least one embodiment, the PDs can all be non-volatile SSDs, such as flash-based storage devices and storage class memory (SCM) devices. It should be noted that the two nodes configured as a pair can also sometimes be referred to as peer nodes. For example, the node A 102a is the peer node of the node B 102b, and the node B 102b is the peer node of the node A 102a.

In at least one embodiment, the data storage system can be configured to provide both block and file storage services with a system software stack that includes an operating system running directly on the processors of the nodes of the system.

In at least one embodiment, the data storage system can be configured to provide block-only storage services (e.g., no file storage services). A hypervisor can be installed on each of the nodes to provide a virtualized environment of virtual machines (VMs). The system software stack can execute in the virtualized environment deployed on the hypervisor. The system software stack (sometimes referred to as the software stack or stack) can include an operating system running in the context of a VM of the virtualized environment.

In at least one embodiment, each pair of nodes can be configured in an active-active configuration as described elsewhere herein, such as in connection with FIG. 2A, where each node of the pair has access to the same PDs providing BE storage for high availability. With the active-active configuration of each pair of nodes, both nodes of the pair process I/O operations or commands and also transfer data to and from the BE PDs attached to the pair. In at least one embodiment, BE PDs attached to one pair of nodes is not be shared with other pairs of nodes. A host can access data stored on a BE PD through the node pair associated with or attached to the PD.

In at least one embodiment, each pair of nodes provides a dual node architecture where both nodes of the pair can be identical in terms of hardware and software for redundancy and high availability. Consistent with other discussion herein, each node of a pair can perform processing of the different components (e.g., FA, DA, and the like) in the data path or I/O path as well as the control or management path. Thus, in such an embodiment, different components, such as the FA, DA and the like of FIG. 1, can denote logical or functional components implemented by code executing on the one or more processors of each node. Each node of the pair can include its own resources such as its own local (i.e., used only by the node) resources such as local processor(s), local memory, and the like.

In at least one embodiment, a persisted log can be used for logging user or client operations, such as write I/Os. In at least one embodiment as discussed in more detail elsewhere where herein, the log can also be used to log or record other operations such as operations to create and delete snapshots of storage objects such as volumes or logical devices.

Consistent with other discussion herein, the log can be used to optimize write operation latency. Generally, the write operation writing data is received by the data storage system from a host or other client. The data storage system then performs processing to persistently record the write operation in the log. Once the write operation is persistently recorded in the log, the data storage system can send an acknowledgement to the client regarding successful completion of the write operation. At some point in time subsequent to logging the write or other operation in the log, the write or other operation is flushed or destaged from the log. In connection with flushing the recorded write operation from the log, the data written by the write operation is stored on non-volatile physical storage of a BE PD. The space of the log used to record the write operation that has been flushed can now be reclaimed for reuse. The write operation can be recorded in the log in any suitable manner and can include, for example, recording a target logical address to which the write operation is directed and recording the data written to the target logical address by the write operation. More generally, once an entry of recorded operation of the log is flushed from the log, the log space of the flushed entry can be reclaimed and reused.

In the log in at least one embodiment, each logged operation can be recorded in the next logically sequential record of the log. For example, a logged write I/O and write data (e.g., write I/O payload) can be recorded in a next logically sequential record of the log. The log can be circular in nature in that once a write operation is recorded in the last record of the log, recording of the next write proceeds with recording in the first record of the log.

The typical I/O pattern for the log as a result of recording write I/Os and possibly other information in successive consecutive log records includes logically sequential and logically contiguous writes (e.g., logically with respect to the logical offset or ordering within the log). Data can also be read from the log as needed (e.g., depending on the particular use or application of the log) so typical I/O patterns can also include reads. The log can have a physical storage layout corresponding to the sequential and contiguous order in which the data is written to the log. Thus, the log data can be written to sequential and consecutive physical storage locations in a manner corresponding to the logical sequential and contiguous order of the data in the log. Additional detail regarding use and implementation of the log in at least one embodiment in accordance with the techniques of the present disclosure is provided below.

Referring to FIG. 2B, shown is an example 200 illustrating a sequential stream 220 of operations or requests received that are written to a log in an embodiment in accordance with the techniques of the present disclosure. In this example, the log can be stored on the LUN 11 where logged operations or requests, such as write I/Os that write user data to a file, target LUN or other storage object, are recorded as records in the log. The element 220 includes information or records of the log for 3 write I/Os or updates which are recorded in the records or blocks I 221, I+1222 and I+2223 of the log (e.g., where I denotes an integer offset of a record or logical location in the log). The blocks I 221, I+1222, and I+2223 can be written sequentially in the foregoing order for processing in the data storage system. The block 221 can correspond to the record or block I of the log stored at LUN 11, LBA 0 that logs a first write I/O operation. The first write I/O operation can write “ABCD” to the target logical address LUN 1, LBA 0. The block 222 can correspond to the record or block I+1 of the log stored at LUN 11, LBA 1 that logs a second write I/O operation. The second write I/O operation can write “EFGH” to the target logical address LUN 1, LBA 5. The block 223 can correspond to the record or block I+2 of the log stored at LUN 11, LBA 2 that logs a third write I/O operation. The third write I/O operation can write “WXYZ” to the target logical address LUN 1, LBA 10. Thus, each of the foregoing 3 write I/O operations logged in 221, 222 and 223 write to 3 different logical target addresses or locations each denoted by a target LUN and logical offset on the target LUN. As illustrated in the FIG. 2B, the information recorded in each of the foregoing records or blocks 221, 222 and 223 of the log can include the target logical address to which data is written and the write data written to the target logical address.

The head pointer 224 can denote the next free record or block of the log used to record or log the next write I/O operation. The head pointer can be advanced 224a to the next record in the log as each next write I/O operation is recorded. When the head pointer 224 reaches the end of the log by writing to the last sequential block or record of the log, the head pointer can advance 203 to the first sequential block or record of the log in a circular manner and continue processing. The tail pointer 226 can denote the next record or block of a recorded write I/O operation in the log to be destaged and flushed from the log. Recorded or logged write I/Os of the log are processed and flushed whereby the recorded write I/O operation that writes to a target logical address or location (e.g., target LUN and offset) is read from the log and then executed or applied to a non-volatile BE PD location mapped to the target logical address (e.g., where the BE PD location stores the data content of the target logical address). Thus, as records are flushed from the log, the tail pointer 226 can logically advance 226a sequentially (e.g., advance to the right toward the head pointer and toward the end of the log) to a new tail position. Once a record or block of the log is flushed, the record or block is freed for reuse in recording another write I/O operation. When the tail pointer reaches the end of the log by flushing the last sequential block or record of the log, the tail pointer advances 203 to the first sequential block or record of the log in a circular manner and continue processing. Thus, the circular logical manner in which the records or blocks of the log are processed form a ring buffer in which the write I/Os are recorded.

When a write I/O operation writing user data to a target logical address is persistently recorded and stored in the non-volatile log, the write I/O operation is considered complete and can be acknowledged as complete to the host or other client originating the write I/O operation to reduce the write I/O latency and response time. The write I/O operation and write data are destaged at a later point in time during a flushing process that flushes a recorded write of the log to the BE non-volatile PDs, updates and writes any corresponding metadata for the flushed write I/O operation, and frees the record or block of the log (e.g., where the record or block logged the write I/O operation just flushed). The metadata updated as part of the flushing process for the target logical address of the write I/O operation can include mapping information as described elsewhere herein. The mapping information of the metadata for the target logical address can identify the physical address or location on provisioned physical storage on a non-volatile BE PD storing the data of the target logical address. The target logical address can be, for example, a logical address on a logical device, such as a LUN and offset or LBA on the LUN.

Referring to FIG. 2C, shown is an example of information that can be included in a log, such as a log of user or client write operations, in an embodiment in accordance with the techniques of the present disclosure.

The example 700 includes the head pointer 704 and the tail pointer 702. The elements 710, 712, 714, 718, 720 and 722 denote 6 records of the log for 6 write I/O operations recorded in the log. The element 710 is a log record for a write operation that writes “ABCD” to the LUN 1, LBA 0. The element 712 is a log record for a write operation that writes “EFGH” to the LUN 1, LBA 5. The element 714 is a log record for a write operation that writes “WXYZ” to the LUN 1, LBA 10. The element 718 is a log record for a write operation that writes “DATA1” to the LUN 1, LBA 0. The element 720 is a log record for a write operation that writes “DATA2” to the LUN 2, LBA 20. The element 722 is a log record for a write operation that writes “DATA3” to the LUN 2, LBA 30. As illustrated in FIG. 2C, the log records 710, 712, 714, 718, 720 and 722 can also record the write data (e.g., write I/O operation payload) written by the write operations. It should be noted that the log records 710, 712 and 714 of FIG. 2C correspond respectively to the log records 221, 222 and 223 of FIG. 2B.

The log can be flushed sequentially or in any suitable manner to maintain desired data consistency. In order to maintain data consistency when flushing the log, constraints can be placed on an order in which the records of the log are flushed or logically applied to the stored data while still allowing any desired optimizations. In some embodiments, portions of the log can be flushed in parallel in accordance with any necessary constraints needed in order to maintain data consistency. Such constraints can consider any possible data dependencies between logged writes (e.g., two logged writes that write to the same logical address) and other logged operations in order to ensure write order consistency.

Referring to FIG. 2D, shown is an example 600 illustrating the flushing of logged writes and the physical data layout of user data on BE PDs in at least one embodiment in accordance with the techniques of the present disclosure. FIG. 2D includes the log 620, the mapping information A 610, and the physical storage (i.e., BE PDs) 640. The element 630 represents the physical layout of the user data as stored on the physical storage 640. The element 610 can represent the logical to physical storage mapping information A 610 created for 3 write I/O operations recorded in the log records or blocks 221, 222 and 223.

The mapping information A 610 includes the elements 611a-c denoting the mapping information, respectively, for the 3 target logical address of the 3 recorded write I/O operations in the log records 221, 222, and 223. The element 611a of the mapping information denotes the mapping information for the target logical address LUN1, LBA 0 of the block 221 of the log 620. In particular, the block 221 and mapping information 611a indicate that the user data “ABCD” written to LUN 1, LBA 0 is stored at the physical location (PD location) P1 633a on the physical storage 640. The element 611b of the mapping information denotes the mapping information for the target logical address LUN1, LBA 5 of the block 222 of the log 620. In particular, the block 222 and mapping information 611b indicate that the user data “EFGH” written to LUN 1, LBA 5 is stored at the physical location (PD location) P2 633b on the physical storage 640. The element 611c of the mapping information denotes the mapping information for the target logical address LUN 1, LBA 10 of the block 223 of the log 620. In particular, the block 223 and mapping information 611 indicate that the user data “WXYZ” written to LUN 1, LBA 10 is stored at the physical location (PD location) P3 633c on the physical storage 640.

The mapped physical storage 630 illustrates the sequential contiguous manner in which user data can be stored and written to the physical storage 640 as the log records or blocks are flushed. In this example, the records of the log 620 can be flushed and processing sequentially (e.g., such as described in connection with FIG. 2B) and the user data of the logged writes can be sequentially written to the mapped physical storage 630 as the records of the log are sequentially processed. As the user data pages of the logged writes to the target logical addresses are written out to sequential physical locations on the mapped physical storage 630, corresponding mapping information for the target logical addresses can be updated. The user data of the logged writes can be written to mapped physical storage sequentially as follows: 632, 633a, 633b, 633c and 634. The element 632 denotes the physical locations of the user data written and stored on the BE PDs for the log records processed prior to the block or record 221. The element 633a denotes the PD location P1 of the user data “ABCD” stored at LUN 1, LBA 1. The element 633b denotes the PD location P2 of the user data “EFGH” stored at LUN 1, LBA 5. The element 633c denotes the PD location P3 of the user data “WXYZ” stored at LUN 1, LBA 10. The element 634 denotes the physical locations of the user data written and stored on the BE PDs for the log records processed after the block or record 223.

In one aspect, the data layout (e.g., format or structure) of the log-based data of the log 620 as stored on non-volatile storage can also be physically sequential and contiguous where the non-volatile storage used for the log can be viewed logically as one large log having data that is layed out sequentially in the order it is written to the log.

The data layout of the user data as stored on the BE PDs can also be physically sequential and contiguous. As log records of the log 620 are flushed, the user data written by each flushed log record can be stored at the next sequential physical location on the BE PDs. Thus, flushing the log can result in writing user data pages or blocks to sequential consecutive physical locations on the BE PDs. In some embodiments, multiple logged writes can be flushed in parallel as a larger chunk to the next sequential chunk or portion of the mapped physical storage 630.

Consistent with other discussion herein, the mapped physical storage 630 can correspond to the BE PDs providing BE non-volatile storage used for persistently storing user data as well as metadata, such as the mapping information.

Thus in at least one embodiment, the data storage system can maintain the user data (UD) or client data, as stored persistently on non-volatile BE storage, as an LSS which can be characterized by not performing in place updates which overwrite existing content. In the LSS for user data, flushing one or more UD log entries of updates to a UD page stored at an existing physical storage location (e.g., on BE PDs) can include determining an updated version of the UD page and storing the updated version of the UD page at a new physical storage location that is different from the existing physical storage location. Thus, the physical storage location of the UD page (as stored persistently on the BE PDs) can move or change each time an updated version of the UD page is written to the BE PDs, where such updated version of the UD page can be the result of flushing one or more entries from the UD log which update the same UD page, and then persistently storing the updated version of the UD page on the BE PDs.

In at least one embodiment consistent with other discussion herein, a write I/O such as from a host or other storage client can be received at the storage system. The write I/O can write UD to a logical address. The storage system can persistently record the write I/O in an entry of the UD log (also sometimes referred to simply as a log), and then return an acknowledgement regarding completion of the write I/O to the host or other client that sent the write I/O. At a later point in time, the entry of the recorded write I/O can be flushed from the UD log. In at least one embodiment, entries of the UD log can be flushed by multiple flush threads that can execute in parallel each performing a flush workflow or flush processing for a different portion of recorded UD log entries. In at least one embodiment, flush thread processing for a recorded write I/O of the UD log can include: creating and/or updating one or more metadata (MD) pages of a chain of MD pages denoting mapping information that maps a logical address LA1 to a corresponding physical address or location PA1 on BE non-volatile storage, where LA1 is the logical address written to by the recorded write I/O and where PA1 is the content written by the recorded write I/O. Thus in at least one embodiment, each of the flush threads can issue one or more allocation requests for new pages of BE non-volatile storage each used to persistently store a corresponding MD page of the chain of MD pages for a recorded write I/O of the UD log being flushed by a respective flush thread. Put another way, for a log entry of a write I/O that is flushed from the log by a flush thread, the flush thread can issue an allocation request for a page of BE non-volatile storage when the flush thread persistently stores a MD page of the chain of MD pages used in connection with mapping LA1 to PA1 for the write I/O.

The following paragraphs illustrate use of the techniques of the present disclosure in at least one embodiment where the resource type or classification is pages of BE non-volatile storage, and where each resource instance is a page of BE non-volatile storage for persistently storing MD. Thus in at least one embodiment, the techniques of the present disclosure can be used in connection with management and allocation of pages of BE non-volatile storage for persistently storing MD. More generally, the techniques of the present disclosure can be used in connection with allocation and management of other suitable resource types or classes.

The following paragraphs use examples of particular values for K, D, S and MAX with respect to a particular resource type to illustrate use of the techniques of the present disclosure in at least one embodiment. More generally, the techniques of the present disclosure can be used with any suitable values for K, D, S and MAX for any suitable resource class or type.

In the following paragraphs and consistent with other discussion herein:

K can denote the number of resource instances in the system that can be allocated and managed using the techniques of the present disclosure;

D can denote the number of domains;

S can denote the number of resource instances in each of the D domains; and

MAX can denote the maximum number of times the try-lock can be used in connection with attempting to lock and thus allocate a free resource instance.

In at least one embodiment as discussed below, MAX can be equal to S.

In at least one embodiment as discussed below, assume that K=100, D=10, S=10 and MAX=10.

In at least one embodiment, each of the resource instances can be a page of BE non-volatile storage for persistently storing a page of MD. In at least one embodiment, flush processing as performed by flush threads can issue an allocation request for a page of non-volatile storage for storing MD in connection with flush workflow processing.

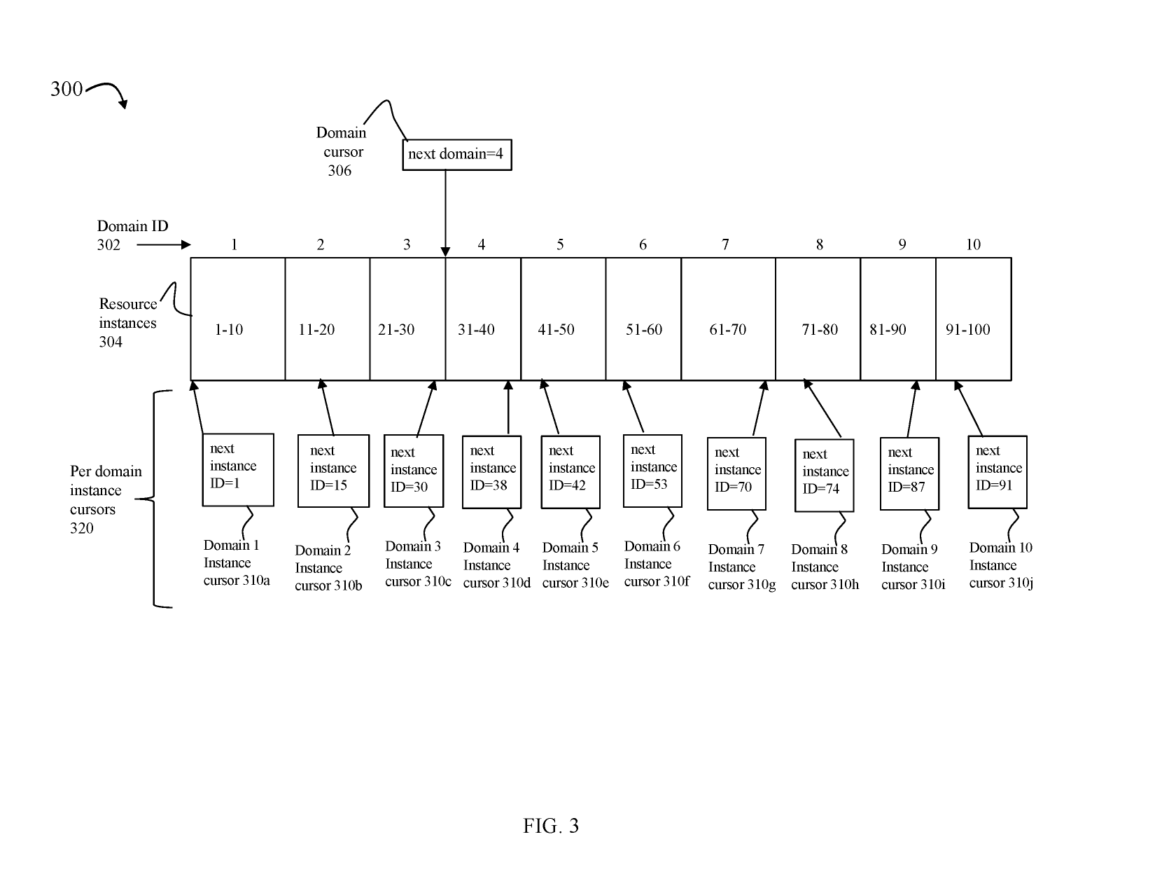

Referring to FIG. 3, shown is an example 300 illustrating resource instances and domains in at least one embodiment in accordance with the techniques of the present disclosure.

In the example 300, K=100 resource instances, D=10, S=10 and MAX=S=10.

In at least one embodiment of the techniques of the present disclosure, the K resource instances can be logically partitioned into D domains each of S resource instances.

Element 304 denotes the K=100 resource instances that are partitioned into D=10 domains. Each of the domains can have a corresponding domain ID 302. Collectively, the domain IDs can form a range R1 of consecutive integers such as from 1-10 in this example. The resource instances 304 can have corresponding resource instance IDs, where each resource instance of 304 can be uniquely identified using a corresponding single one of the resource instance IDs. Collectively, the K resource IDs can form a range R2 of consecutive integers such as from 1-100. Each of the D domains can include S resource instances having corresponding resource instance IDs that form a subrange of consecutive integers of R2. The subrange can denote a portion of the consecutive resource IDs of R2.

In the example 300, each of the 10 domains can have a corresponding domain ID 302, where each domain is of size S denoting that each domain has 10 resource instances. In the example 300, domain 1 has resource instances 1-10, domain 2 has resource instances 11-20, domain 3 has resource instances 21-30, domain 4 has resource instances 31-40, domain 5 has resource instances 41-50, domain 6 has resource instances 51-60, domain 7 has resource instances 61-70, domain 8 has resource instances 71-80, domain 9 has resource instances 81-90, and domain 10 has resource instances 91-100.

The techniques of the present disclosure can include maintaining the domain cursor 306 and per domain instance cursors 320.

The domain cursor 306 can track the next domain index identifying the next domain from which a resource instance is allocated from in connection with the next resource allocation request. The domain cursor 306 can be advanced in a RR manner to a next domain such that each new resource allocation request can attempt to allocate a resource instance from the next domain in the sequence or cycle of domain IDs. For example, in FIG. 3 the domain cursor 306 is currently 4 indicating that the next resource allocation request N will allocate a resource instance from domain 4 that includes instances 31-40. The domain cursor 306 can then be advanced to 5 such that the next resource allocation request N+1 is allocated from domain 5. In this example, advancing the domain cursor can include incrementing the domain cursor’s value (denoting a domain index) by 1 for each new resource allocation request. Once the last domain ID=10 is reached by the domain cursor, the domain cursor can then advance back to the first domain ID=1 in a cyclic manner. Thus in at least one embodiment, the domain cursor can be advanced by either incrementing the domain cursor by 1, or otherwise resetting the domain cursor back to 1 (in the case where the domain cursor prior to advancing is 10). Thus the domain cursor 306 can be used to traverse, in a RR manner, the D domains such that a resource instance is allocated from each of the D domains in connection with corresponding resource allocation requests.

Each of the domains can have a corresponding one of the domain instance cursors 320 to track the next instance ID of a respective resource instance to attempt to allocate in the particular domain. In the example 300, the per domain instance cursors 320 include 10 domain instance cursors 310a-j. Domain 1 instance cursor 310a for domain 1=1. Domain 2 instance cursor 310b for domain 2=15. Domain 3 instance cursor 310c for domain 3=30. Domain 4 instance cursor 310d for domain 4=38. Domain 5 instance cursor 310e for domain 5=42. Domain 6 instance cursor 310f for domain 6=53. Domain 7 instance cursor 310g for domain 7=70. Domain 8 instance cursor 310h for domain 8=74. Domain 9 instance cursor 310i for domain 9=87. Domain 10 instance cursor 310j for domain 10=91. A domain’s corresponding instance cursor of 320 can be used in connection with traversing through resource instances of the corresponding domain to locate a free resource instance to allocate in connection with a current allocation request. For example, assume an allocation request for a resource instance is received and the domain cursor 306 identifies domain 4 as in FIG. 3. Subsequently, domain 4 of resource instances 31-40 can be searched to locate a free resource instance to be allocated to satisfy the allocation request. Processing can begin the search with the resource instance having the corresponding instance ID=38 as denoted by the domain 4 instance cursor 310d. If resource instance 38 is locked and thus not free, the domain 4 instance cursor 310d can be advanced to the next instance ID of 39. Thus domain 4’s instance cursor 310d can be advanced in a manner similar to that as discussed above in connection with the domain cursor 306 in attempts to allocate a corresponding resource instance having the particular resource instance ID denoted by domain 4 instance cursor 310d. In particular, domain 4’s instance cursor 310d can be advanced by either incrementing the instance cursor 310d by 1, or otherwise resetting the instance cursor 310d back to 31, the lowest or starting instance ID of the current domain 4. The instance cursor 310d can be reset to 31 if, prior to advancing, the instance cursor 310d=40 (e.g., the highest instance ID of domain 4). Thus each of the domain instance cursors 310a-j can be used to traverse, in a RR manner, resource instances of a respective domain when attempting to locate a free resource instance of the respective domain.

In at least one embodiment, each such attempt to allocate the corresponding resource instance can be a try-lock allocation request. In at least one embodiment, at most MAX try-lock allocation requests can be made to locate a free resource instance for allocation. For example, MAX=S=10 in this example such that at most 10 try-lock allocation requests can be made to locate a free resource instance for allocation. If, prior to exhausting the allowed MAX try-lock request, a try-lock allocation request succeeds in locking a corresponding resource instance of domain 4 (indicating that that corresponding resource instance is free), then the corresponding resource instance is acquired and used to satisfy the current allocation request (e.g., is allocated to the requesting thread that issued the current allocation request). Otherwise, if domain 4 instance cursor 310d advances 10 times and fails to locate a free resource instance for allocation in domain 4, a hard-lock allocation request is issued where the requesting thread waits on a wait queue associated with the current resource instance having the resource instance ID=38. If the domain 4 instance cursor 310d advances 10 times and fails to locate a free resource instance in domain 4, the cursor 310d will once again have the value of 38.

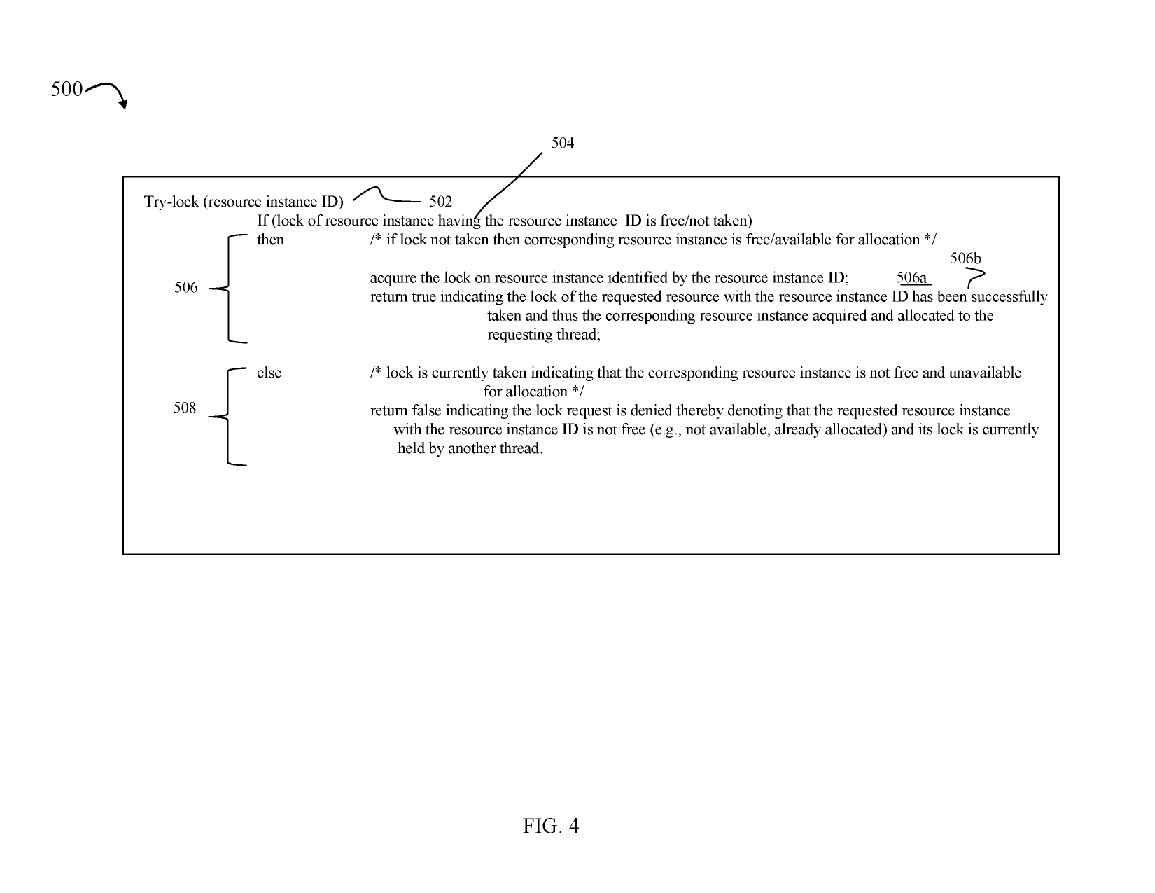

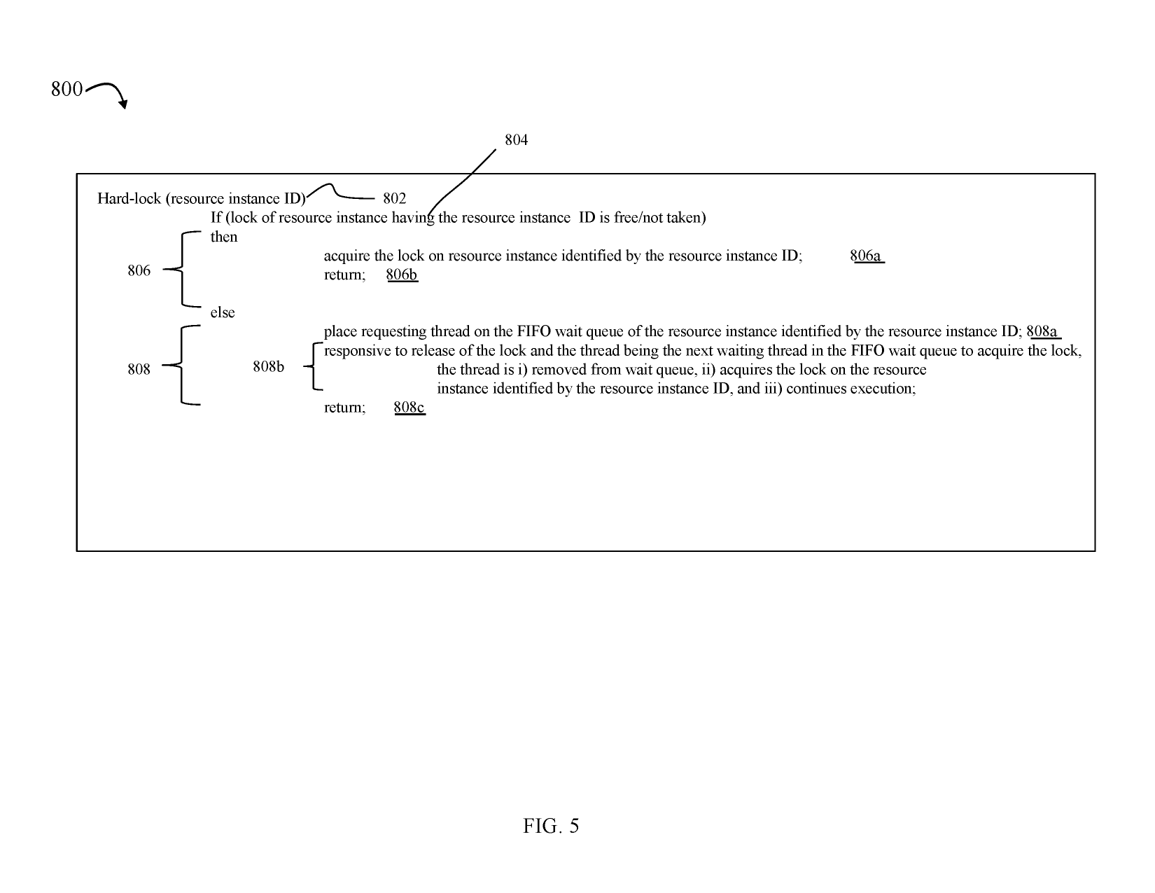

Further detail regarding the semantics and pseudo-code of try-lock and hard-lock requests in at least one embodiment are discussed in more detail below and elsewhere herein. In at least one embodiment, each try-lock request can be in accordance with the example 500 of FIG. 4 discussed below, and each hard-lock request can be in accordance with the example 600 of FIG. 5 discussed below.

In at least one embodiment, a try-lock request can be a non-blocking lock request that attempts to acquire a lock on a particular resource instance having a specified resource instance ID.

Referring to FIG. 4, shown is an example 500 illustrating pseudo-code of the try-lock in at least one embodiment in accordance with the techniques of the present disclosure.

Line 502 illustrates a try-lock call or request that can be specified as:

Try-lock (resource instance ID) where the resource instance ID is an input parameter that identifies a corresponding resource instance for which the lock is being requested.

In at least one embodiment, code implanting try-lock can be included in the cache component managing the resource instances. In at least one embodiment, try-lock calls or requests can be made from a resource allocator to the cache component.

In at least one embodiment, the try-lock semantics can be represented by the pseudo-code of 500 that generally includes a single if-then-else statement.

Line 504 specifies the condition of the if statement evaluated to determine whether the lock of the resource instance having the specified resource instance ID (e.g., provided as the input parameter of 502) is free or not taken. If the condition of 504 evaluates to true whereby the lock is free or not taken, processing of the “then” portion 506 is performed. Otherwise, if the condition of 504 evaluates to false where the lock is not free and is taken, processing of the “else” portion 508 is performed.

If the lock corresponding to the resource instance ID is not taken whereby the condition of 504 evaluates to true, then i) acquire the lock on resource instance identified by the resource instance ID (506a); and ii) return true indicating the lock of the requested resource with the resource instance ID has been successfully taken and thus the corresponding resource instance acquired (506b).

If the lock corresponding to the resource instance ID is taken whereby the condition of 504 evaluates to false, then return false indicating the lock request is denied thereby denoting that the requested resource instance with the resource instance ID is not free (e.g., not available, already allocated) and its lock is currently held by another thread (508).

Thus the logic or semantics of the try-lock request can be characterized as non-blocking in that a requesting thread requesting the lock on the resource instance identified by the resource instance ID input parameter of 502 does not have its execution blocked waiting for the requested lock, and thus corresponding resource instance, to become free or available. The try-lock request of 500 can query whether the requested lock is currently taken, and if not, can take the lock. Otherwise, if the requested lock is currently taken and not available (e.g., held by another thread), then the try-lock request is denied or fails resulting in false being returned.

In at least one embodiment, the techniques of the present disclosure provide for placing a limit (e.g., MAX) on the maximum number of attempts allowed to be performed using try-lock requests to obtain a lock on a corresponding resource instance. In at least one embodiment, the foregoing limit, MAX, can denote a maximum number of attempts performed using try-lock requests with different resource instance IDs in the same domain, where each such try-lock request attempts to acquire a lock on a next resource instance having a corresponding resource instance ID in the same domain. Once MAX attempts have been reached resulting in unsuccessfully acquiring a lock on a free resource instance, the techniques of the present disclosure can utilize a hard-lock.

In at least one embodiment, a hard-lock request can be a blocking lock request that attempts to acquire a lock on a particular resource instance having a specified resource instance ID such that the requesting thread can be blocked or wait if the requested lock is not free or currently taken.

Referring to FIG. 5, shown is an example 800 illustrating pseudo-code of the hard-lock in at least one embodiment in accordance with the techniques of the present disclosure.

Line 802 illustrates a hard-lock call or request that can be specified as:

Hard-lock (resource instance ID) where the resource instance ID is an input parameter that identifies a corresponding resource instance for which the lock is being requested.

In at least one embodiment, hard-lock can be included in the cache component managing the resource instances. In at least one embodiment, hard-lock calls or requests can be made from a resource allocator to the cache component.

In at least one embodiment, the hard-lock semantics can be represented by the pseudo-code of 800 that generally includes a single if-then-else statement.

Line 804 specifies the condition of the if statement evaluated to determine whether the lock of the resource instance having the specified resource instance ID (e.g., provided as the input parameter of 802) is free or not taken. If the condition of 804 evaluates to true whereby the lock is free or not taken, processing of the “then” portion 806 is performed. Otherwise, if the condition of 804 evaluates to false where the lock is not free and is taken, processing of the “else” portion 808 is performed.

If the lock corresponding to the resource instance ID is not taken whereby the condition of 804 evaluates to true, then i) acquire the lock on resource instance identified by the resource instance ID (806a); and ii) return (806b) such that the requesting thread continues execution.

If the lock corresponding to the resource instance ID is taken whereby the condition of 804 evaluates to false (e.g., indicating the requested resource instance with the resource instance ID is not free and its lock is currently held by another thread), then place the requesting thread on the FIFO wait queue of the resource instance identified by the resource instance ID (808a).

At a later point in time after the thread is placed on the wait queue (808a), step 808b is performed that includes removing the thread from the wait queue based on the FIFO ordering of the threads of the wait queue whereby the thread acquires the lock. With reference to the example 800, responsive to release of the lock and the thread being the next waiting thread in the FIFO wait queue to acquire the lock, the thread i) is removed from the wait queue, ii) acquires the lock on the resource instance identified by the resource instance ID, and iii) continues execution. Following the step 808b, control returns 808c thereby allowing the thread that just acquired the lock to continue execution.

Thus the logic or semantics of the hard-lock request can be characterized as blocking in that the requesting thread requesting the lock (on the resource instance identified by the resource instance ID input parameter of 502) has its execution blocked waiting on the wait queue for the requested lock, and thus corresponding resource instance, to become free or available.

It should be noted that the foregoing provides details regarding implementation of the try-lock and hard-lock in at least one embodiment. In at least one embodiment, the allocated resource instance can be referenced using its corresponding resource instance ID.

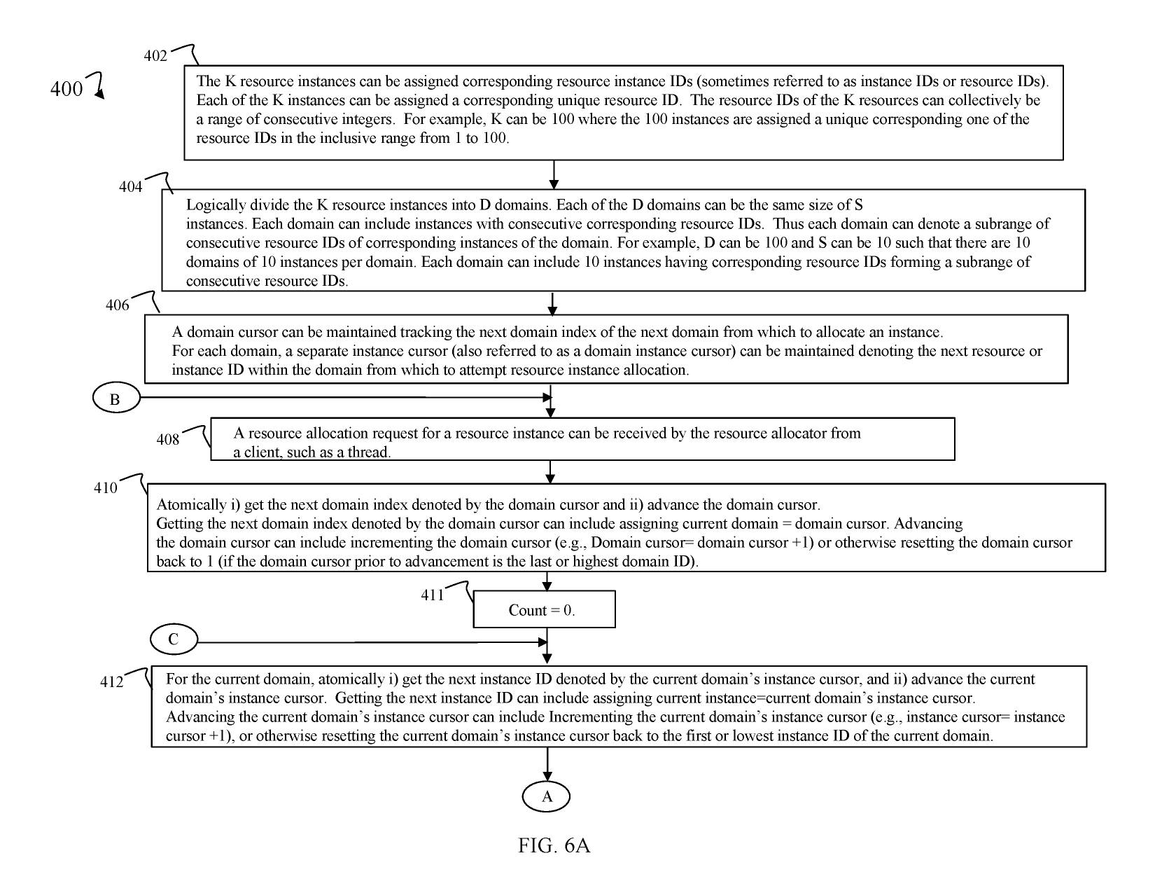

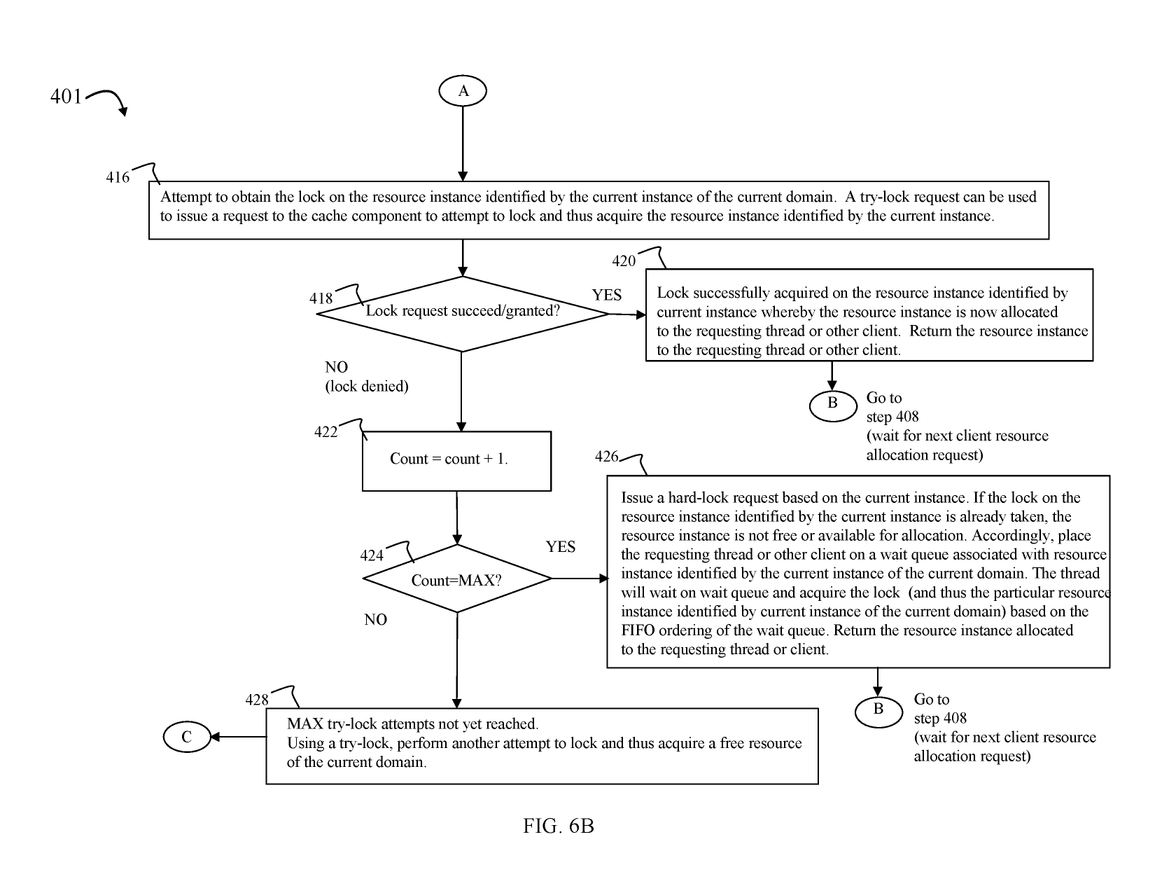

Referring to FIGS. 6A and 6B, shown is a flowchart 400, 401 of processing steps that can be performed in at least one embodiment in accordance with the techniques of the present disclosure. FIGS. 6A and 6B summarize processing discussed above.

At the step 402, the K resource instances can be assigned corresponding resource instance IDs (sometimes referred to as instance IDs or resource IDs). Each of the K instances can be assigned a corresponding unique resource ID. The resource IDs of the K resources can collectively be a range of consecutive integers. For example with reference back to FIG. 3, K can be 100 where the 100 instances are assigned a unique corresponding one of the resource IDs in the inclusive range from 1 to 100. From the step 402, control proceeds to the step 404.

At the step 404, logically divide the K resource instances into D domains. Each of the D domains can be the same size of S instances. Each domain can include instances with consecutive corresponding resource IDs. Thus each domain can denote a subrange of consecutive resource IDs of corresponding instances of the domain. For example with reference back to FIG. 3, D can be 100 and S can be 10 such that there are 10 domains of 10 instances per domain. Each domain can include 10 instances having corresponding resource IDs forming a subrange of consecutive resource IDs. From the step 404, control proceeds to the step 406.

At the step 406, a domain cursor can be maintained tracking the next domain index that identifies the next domain from which to allocate an instance. For each domain, a separate instance cursor (also referred to as a domain instance cursor) can be maintained denoting the next resource or instance ID within the domain from which to attempt resource instance allocation. From the step 406, control proceeds to the step 408.

At the step 408, A resource allocation request for a resource instance can be received by the resource allocator from a client, such as a thread. From the step 408, control proceeds to the step 410 to commence processing responsive to the resource allocation request. In at least one embodiment, processing of steps 410, 412, 416, 418, 420, 422, 424, 426 and 428 can be performed by the resource allocator.

At the step 410, processing is performed to atomically: i) get the next domain index denoted by the domain cursor and ii) advance the domain cursor. Getting the next domain index denoted by the domain cursor can include assigning current domain = domain cursor. Advancing the domain cursor can include incrementing the domain cursor (e.g., Domain cursor= domain cursor +1) or otherwise resetting the domain cursor back to 1 (if the domain cursor prior to advancement is the last or highest domain ID). For example with reference back to FIG. 3, the current domain can be assigned the value of 4 as identified by the domain cursor 306. Additionally, the domain cursor 306 can be advanced to 5 so that the next resource allocation request is allocated from domain 5. From the step 410, control proceeds to the step 411.

At the step 411, a variable count is initialized to 0. From the step 411, control proceeds to the step 412.

At the step 412, for the current domain, atomically i) get the next instance ID denoted by the current domain’s instance cursor, and ii) advance the current domain’s instance cursor. Getting the next instance ID can include assigning current instance=current domain’s instance cursor. Advancing the current domain’s instance cursor can include Incrementing the current domain’s instance cursor (e.g., instance cursor= instance cursor +1), or otherwise resetting the current domain’s instance cursor back to the first or lowest instance ID of the current domain. For example with reference back to FIG. 3, the current domain can be 4 as assigned in the step 410. Accordingly in the step 412, current instance can be assigned the value of 38 as identified by the domain 4 instance cursor 310d. Thus current instance can denote the resource instance ID or instance ID of a corresponding resource instance for which a subsequent try-lock request is issued (in step 416). Additionally, the domain 4 instance cursor 310d can be advanced to 39. From the step 412, control proceeds to the step 416.

At the step 416, processing can be performed to attempt to obtain the lock on the resource instance identified by the current instance of the current domain. A try-lock request can be used to issue a request to the cache component to attempt to lock and thus acquire the resource instance identified by the current instance. For example, a try-lock request can be issued such as described in connection with FIG. 5, where the try-lock request can be issued requesting the lock on the resource instance identified by 38, the current instance. In response to the try-lock request for the resource instance having the resource instance ID=38, processing described elsewhere herein (e.g., in FIG. 5) can be performed. In at least one embodiment, the try-lock request processing can return either true (indicating the lock request succeeded) or false (indicating the lock request failed). From the step 416, control proceeds to the step 418.

At the step 418, a determination is made as to whether the lock request of step 416 succeeded. If the lock request succeeded such that the lock for the resource instance with the resource instance ID=38 is granted, step 418 evaluates to yes and control proceeds to the step 420. At the step 420, it is determined that the lock was successfully acquired on the resource instance identified by the current instance whereby the resource instance is now allocated to the requesting thread or other client. Processing can then return the allocated resource instance having the resource instance ID=38 to the requesting thread or other client in response to the request (e.g., as received in the step 408). From the step 420, the allocator can return to the step 408 to wait for the next client resource allocation request.

If the lock request of the step 416 failed or is denied, step 418 evaluates to no and control proceeds to the step 422. At the step 422, count is incremented by 1. From the step 422 control proceeds to the step 424.

At the step 424, a determination is made as to whether count is equal to MAX. If the step 424 evaluates to yes, control proceeds to the step 426. At the step 426, processing can be performed to issue a hard-lock request based on the current instance. The hard-lock request and associated processing can be as described, for example in FIG. 6. If the lock on the resource instance identified by the current instance is already taken, the resource instance is not free or available for allocation. Accordingly, the hard-lock request processing will place the requesting thread or other client on a wait queue associated with the resource instance identified by the current instance of the current domain. The thread will wait on the wait queue and acquire the lock (and thus the particular resource instance identified by current instance of the current domain) based on the FIFO ordering of the wait queue. Once the lock is acquired by the thread, the resource instance has been allocated to the thread or client and can be returned to the requesting thread or client. From the step 424, the allocator can return to the step 408 to wait for the next client resource allocation request.

If the step 424 evaluates to no, control proceeds to the step 428 where it is determined that the (MAX) maximum allowable number of try-lock attempts have not been yet been performed. As a result using the try-lock request, processing can continue to perform another attempt to lock and thus acquire a free resource instance of the current domain. From the step 424, control proceeds to the step 412 where the allocator continues to search for current domain in a RR manner for a free resource instance. For example, assume that the try-lock request of the step 416 for the resource instance with the resource instance ID=38 is denied thereby causing step 418 to evaluate to no. In the step 422, count is incremented from 0 to 1 and step 424 evaluates to no so that processing continues with step 428 and then step 412. At this point, the domain 4 instance cursor 310d = 39 so that in the step 412, the current instance is updated to 39 and the domain 4 instance cursor 310d is advanced to 40. Processing of FIGS. 6A-6B can continue to perform a try-lock request for the resource instance with the resource instance ID of 39. Consistent with discussion above, processing of FIGS. 6A and 6B can continue until a resource instance of the current domain 4 is allocated using the try-lock request or the hard-lock request processing.

Continuing with the above example, assume that a resource instance is allocated from domain 4 in response to a first resource allocation request. Subsquently, control can wait at step 408 until another second resource allocation request is issued by a thread. At this point when performing processing beginning at step 410 responsive to the second resource allocation request, the domain cursor is 5 whereby a second resource instance will be allocated from domain 5 to satisfy the second allocation request. In connection with further processing of FIGS. 6A and 6B, the second resource instance of domain 5 can be allocated as a result of either a successful try-lock request or, if MAX try-lock requests are unsuccessful or fail, a hard-lock request.

In a manner consistent with the above discussion other subsequent resource allocation requests can result in allocating corresponding resource instances from successive domains in a RR manner based on the advancement of the domain cursor with each new resource allocation request.

It should be noted that in connection with the above example with 10 domains, a resource instance can be allocated from the same domain after 10 requests are received. For example, assume that request 1 results in allocating a resource instance of domain 4. Assume that 10 more additional requests are received where each of the requests can result in allocation of a resource instance respectively from domains 5, 6, 7, 8, 9, 10, 1, 2, 3, and 4. Thus the 10^{th} or last additional request in the foregoing can be serviced by allocating a resource instance from domain 4 again. In connection with the 10^{th} or last additional request, resource instance allocation attempts can resume based on the current value of domain instance cursor 310d. For example with reference back to FIG. 3, if request 1 results in allocation of the resource instance with instance ID=39, resource allocation attempts in connection with the 10^{th} or last additional request can commence with instance ID=40 as denoted by the domain 4 instance cursor 310d. Thus in at least one embodiment, a subsequent resource allocation attempt of a resource instance of domain 4 for request 11 can commence with the next resource instance (with ID=40) in domain 4 following the immediately prior allocated resource instance (with ID=39) as denoted by the cursor 310d.

As discussed above, the techniques of the present disclosure provide for an optimized technique for resource instance allocation using a two-level RR approach. A first level of RR selection is in connection with the domain cursor and domain selection that provides for allocating successive resource instances from successive domains. A second level of RR selection is in connection with the domain instance cursors 320 that provide for attempting resource instance allocation of each domain using a corresponding one of the domain instance cursors.

In at least one embodiment, the techniques of the present disclosure can be characterized as optimal in multiple respects. The processing can be characterized as deterministic in that at most MAX failed try-lock allocation attempts and a single hard-lock request can be performed for successful allocation. The resource instance allocation using the two-level RR approach can be characterized as balanced and distributed among the domains, with respect to the resource instances of each domain, and also with respect to the waiting queue sizes. The techniques of the present disclosure can provide for optimized utilization of CPU time since busy waiting performed using try-lock attempts is bounded by MAX, and at most MAX+1 allocation attempts can be performed. In at least one embodiment, the techniques of the present disclosure can provide for optimized utilization of the cache component managing the resource instances where the resource allocator can issue the try-lock and hard-lock requests to the cache component. In at least one embodiment in a multi-threaded environment where D can have a value based, at least in part, on the number of threads that can execute in parallel requesting allocation of resource instances, lock contention can be reduced in selecting instance IDs for allocations.

The techniques of the present disclosure provide for a balanced approach for resource allocations using the two-level RR approach. In at least one embodiment, the techniques of the present disclosure provide for limiting the search for a free resource instance to a particular domain, the current domain, and bounding or limiting the number of attempts to locate a free resource instance. The techniques of the present disclosure also provide for a balanced approach by distributing the waiters or waiting threads across wait queues associated with corresponding resource instances.

In at least one embodiment, the number of domains D can be selected as a value based, at least in part, on NN, the number of CPU cores that can execute threads issuing request allocations for resource instances. In at least one embodiment, D can be equal to, or greater than, NN. Thus D can be based, at least in part, on the number of clients of the resource allocation that can execute in parallel on the NN CPU cores. In at least one embodiment, the clients can be flush threads that can issue resource allocation requests to the resource allocator for pages of BE non-volatile storage for storing corresponding MD pages. Generally an embodiment can use any suitable size for D that can vary with embodiment.

In at least one embodiment, MAX can be equal to S, the size of each of the D domains. Generally, an embodiment can use any suitable size for MAX that can vary with embodiment. In selecting a size for MAX, one factor that can be considered is that selecting a value for MAX that is too large can lead to excessive waste of CPU time in connection with looping or traversing resource instances in attempts to locate a free resource instance. Another factor that can be considered is that selecting a value for MAX that is too small can result in larger than desirable wait queues and wait times.

In at least one embodiment, selecting values or sizes for MAX and/or S can be customized and/or tuned for a particular system. For example, the techniques of the present disclosure can be implemented in a system. Processing in the system can be performed using various workloads and client workflows that issue resource allocation requests for resources managed using the techniques of the present disclosure in the implementation. The implementation can perform resource allocation and management using various values for MAX and/or S and then measuring one or more performance metrics or indicators to select particular values for MAX and/or S.

In at least one embodiment that value of MAX can be adaptive and vary over time based, at least in part, on a current workload of the system. For example, if the system workload is below a threshold level, additional system resources such as CPU time can be available to perform additional try-lock attempts. In at least one embodiment, if the system workload is below a threshold level, MAX can be increased by a specified incremental amount. If the system workload then increases above the threshold level, MAX can be accordingly decreased by a specified amount.

In at least one embodiment the particular value selected for MAX can be based, at least in part, on a first variable or term associated with a cost of performing MAX try-lock attempts, and a second variable or term associated with the average latency or amount of time a client waits for an allocation request to be fulfilled or granted (e.g., average latency for servicing an allocation request) when MAX is a particular value. For example, the average latency (e.g., average client request latency) can be the average amount of time a flush thread waits to obtain a requested allocation of a page of BE non-volatile storage for storing MD. In at least one embodiment for a particular value of MAX, the first variable or term can be based, at least in part, on the amount of CPU time it takes to perform the MAX try-lock operations or requests for a particular value of MAX. In at least one embodiment, the second variable or term can be the measured or observed average latency to service a client allocation request when MAX is also the same particular value. As a result in at least one embodiment, different values for the first variable or term and the second variable or term can be determined for corresponding different values of MAX.

In at least one embodiment, it may be desirable not to have the second term or average latency of a client allocation request exceed a specified threshold latency; and/or it may be desirable not to have the first term exceed a specified CPU time threshold or limit. Thus in at least one embodiment, one or more suitable values for MAX can be determined which i) consume no more than a threshold amount of CPU time and/or ii) result in an average client request latency that does not exceeds a corresponding maximum latency.

In at least one embodiment, MAX can be adapted and can vary based on system workloads over time as noted above, where such selected values for MAX can also result in bounded acceptable corresponding try-lock request costs (e.g., first term) and/or bounded acceptable average latency values (e.g., second term or variable). For example, a first threshold TH1 can be specified identifying a maximum allowable latency threshold or upper bound, and a second threshold TH2 can be specified identifying a maximum allowable amount of CPU time allowed to be consumed in connection with try-lock processing. In at least one embodiment, testing can be performed using various values for MAX to determine corresponding resulting values for i) the amount of CPU time consumed in connection with MAX try-lock requests and ii) the average client request latency. In at least one embodiment, the various values for MAX can be selected and adapted for use based, at least in part, on the current workload of the system provided that the selected values for MAX result in i) CPU time consumption for try-lock request processing that is less than TH1, and ii) average client request latency that is less than TH2.

The techniques described in the present disclosure can be performed by any suitable hardware and/or software. For example, techniques herein can be performed by executing code which is stored on any one or more different forms of computer-readable media, where the code is executed by one or more processors, for example, such as processors of a computer or other system, an ASIC (application specific integrated circuit), and the like. Computer-readable media includes different forms of volatile (e.g., RAM) and non-volatile (e.g., ROM, flash memory, magnetic or optical disks, or tape) storage, where such storage includes be removable and non-removable storage media.

While the present disclosure provides various embodiments shown and described in detail, their modifications and improvements will become readily apparent to those skilled in the art. It is intended that the specification and examples be considered as exemplary only with the true scope and spirit of the present disclosure indicated by the following claims.

What is claimed is:

1. A computer-implemented method comprising:
receiving K resource instances each assigned one of K resource identifiers (IDs), wherein the K resource IDs form a first range R1 of consecutive integers;
partitioning the K resource instances into D domains each of size S denoting that said each domain has S resource instances, wherein the S resource instances of said each domain have corresponding resource IDs that form a subrange of consecutive integers, and wherein each of the D domains is assigned one of D domain IDs, wherein the D domain IDs from a second range R2 of consecutive integers;
maintaining a domain cursor and D instance cursors, wherein the domain cursor identifies one of the D domain IDs of a next one of the D domains from which to allocate a resource instance, and wherein each of the D domains has a corresponding one of the D instance cursors denoting a resource ID of a next resource instance of said each domain from which to attempt resource instance allocation;
issuing, by a first thread, a resource allocation request; and
performing first processing to allocate one of the K resource instances for the resource allocation request, including:
determining, in accordance with the domain cursor, a first domain from which to allocate a resource instance, wherein the domain cursor denotes a first domain ID identifying the first domain, and wherein a first instance cursor of the D instance cursors corresponds to the first domain;
performing, based on the first instance cursor, a first plurality of unsuccessful attempts to obtain a resource instance of the first domain that is free, wherein each of the first plurality of unsuccessful attempts is an unsuccessful attempt to obtain a different resource instance of the first domain, wherein the first instance cursor is advanced to a next resource ID of the first domain after each of the first plurality of unsuccessful attempts;
determining whether the first plurality of unsuccessful attempts exceeds a maximum; and
responsive to determining that the first plurality of unsuccessful attempts exceeds the maximum, performing second processing including:
placing the first thread on a first wait queue associated with one resource instance of the first domain, wherein the first thread waits on the first wait queue to acquire said one resource instance of the first domain.

2. The computer-implemented method of claim 1, wherein said placing includes:
adding the first thread to the first wait queue based on a FIFO (first in first out) ordering in which threads attempt to acquire said one resource instance.

3. The computer-implemented method of claim 2, wherein said second processing includes:
detecting that said one resource instance is free and that the first thread is waiting in the first wait queue and is next in line to acquire said one resource instance based on the FIFO ordering; and
the first thread obtaining said one resource instance in response to said resource allocation request whereby said one resource instance is allocated to the first thread.

4. The computer-implemented method of claim 3, wherein the first plurality of unsuccessful attempts is performed with respect to first consecutive resource IDs of respective first resource instances of the first domain.

5. The computer-implemented method of claim 4, wherein each of the first plurality of unsuccessful attempts is a try-lock request that attempts to acquire a lock on a corresponding resource instance of the first domain that has a corresponding one of the first consecutive resource IDs.

6. The computer-implemented method of claim 5, wherein the try-lock request of said each unsuccessful attempt results in third processing including:
determining that the lock, on the corresponding resource instance of the first domain having the corresponding one of the first consecutive resource IDs, is taken; and
responsive to determining that the lock is taken, returning false indicating that the try-lock request has failed and is unsuccessful, wherein failure to acquire the lock indicates that the corresponding resource instance of the first domain having the corresponding one of the first consecutive resource IDs is not free and already allocated.

7. The computer-implemented method of claim 6, wherein execution of the first thread that issued the resource allocation request is not blocked in response to the first plurality of unsuccessful attempts.

8. The computer-implemented method of claim 7, wherein in response to each of the first plurality of unsuccessful attempts to acquire one of the first resource instances, the first thread does not wait for the one resource instance to become free.

9. The computer-implemented method of claim 7, wherein in response to a first unsuccessful attempt of the first plurality to acquire one of the first resource instances, the first thread attempts to acquire another one of the first resource instances.

10. The computer-implemented method of claim 5, wherein the lock is an exclusive lock.

11. The computer-implemented method of claim 1, further comprising:
responsive to determining that the first plurality of unsuccessful attempts does not exceed the maximum, performing third processing including:
performing, based on the first instance cursor, an additional attempt to obtain a first resource instance of the first domain, wherein the first resource instance has a first resource ID; and
responsive to determining that the first resource instance of the first domain is free, allocating the first resource instance to the first thread in response to said resource allocation request.

12. The computer-implemented method of claim 1, wherein the first thread is a flush thread performing processing to flush an entry of a recorded write I/O operation from a log.

13. The computer-implemented method of claim 12, wherein the K resource instances are K pages of back-end (BE) non-volatile storage used for storing metadata (MD).

14. The computer-implemented method of claim 13, wherein the resource allocation request is a request by the flush thread for a free one of the K pages for storing a first MD page in connection with flushing the entry for the recorded write I/O operation from the log.

15. The computer-implemented method of claim 14, wherein the recorded write I/O operation writes first content to a first logical address, and wherein the first MD page is included in a chain of MD pages used to map the first logical address to a physical storage location of the first content as stored on BE non-volatile storage.

16. The computer-implemented method of claim 1, wherein the first processing includes:
advancing the domain cursor from the first domain ID denoting the first domain to a second domain ID identifying a second domain that is different from the first domain;
issuing, by a second thread, a second resource allocation request; and
performing third processing in accordance with the domain cursor to allocate a resource instance of the second domain for the second allocation request, wherein the third processing includes commencing attempts to locate a free resource instance of the second domain based on a current resource ID of the second domain identified by a second instance cursor of the D instance cursors, wherein the second instance cursor corresponds to the second domain.

17. The computer-implemented method of claim 1, wherein the maximum is equal to S.

18. A system comprising:
one or more processors; and
one or more memories comprising code stored thereon that, when executed, performs a method comprising:
receiving K resource instances each assigned one of K resource identifiers (IDs), wherein the K resource IDs form a first range R1 of consecutive integers;
partitioning the K resource instances into D domains each of size S denoting that said each domain has S resource instances, wherein the S resource instances of said each domain have corresponding resource IDs that form a subrange of consecutive integers, and wherein each of the D domains is assigned one of D domain IDs, wherein the D domain IDs from a second range R2 of consecutive integers;
maintaining a domain cursor and D instance cursors, wherein the domain cursor identifies one of the D domain IDs of a next one of the D domains from which to allocate a resource instance, and wherein each of the D domains has a corresponding one of the D instance cursors denoting a resource ID of a next resource instance of said each domain from which to attempt resource instance allocation;
issuing, by a first thread, a resource allocation request; and
performing first processing to allocate one of the K resource instances for the resource allocation request, including:
determining, in accordance with the domain cursor, a first domain from which to allocate a resource instance, wherein the domain cursor denotes a first domain ID identifying the first domain, and wherein a first instance cursor of the D instance cursors corresponds to the first domain;
performing, based on the first instance cursor, a first plurality of unsuccessful attempts to obtain a resource instance of the first domain that is free, wherein each of the first plurality of unsuccessful attempts is an unsuccessful attempt to obtain a different resource instance of the first domain, wherein the first instance cursor is advanced to a next resource ID of the first domain after each of the first plurality of unsuccessful attempts;
determining whether the first plurality of unsuccessful attempts exceeds a maximum; and
responsive to determining that the first plurality of unsuccessful attempts exceeds the maximum, performing second processing including:
placing the first thread on a first wait queue associated with one resource instance of the first domain, wherein the first thread waits on the first wait queue to acquire said one resource instance of the first domain.

19. One or more non-transitory computer-readable media comprising code stored thereon that, when executed, performs a method comprising:
receiving K resource instances each assigned one of K resource identifiers (IDs), wherein the K resource IDs form a first range R1 of consecutive integers;
partitioning the K resource instances into D domains each of size S denoting that said each domain has S resource instances, wherein the S resource instances of said each domain have corresponding resource IDs that form a subrange of consecutive integers, and wherein each of the D domains is assigned one of D domain IDs, wherein the D domain IDs from a second range R2 of consecutive integers;
maintaining a domain cursor and D instance cursors, wherein the domain cursor identifies one of the D domain IDs of a next one of the D domains from which to allocate a resource instance, and wherein each of the D domains has a corresponding one of the D instance cursors denoting a resource ID of a next resource instance of said each domain from which to attempt resource instance allocation;
issuing, by a first thread, a resource allocation request; and
performing first processing to allocate one of the K resource instances for the resource allocation request, including:
determining, in accordance with the domain cursor, a first domain from which to allocate a resource instance, wherein the domain cursor denotes a first domain ID identifying the first domain, and wherein a first instance cursor of the D instance cursors corresponds to the first domain;
performing, based on the first instance cursor, a first plurality of unsuccessful attempts to obtain a resource instance of the first domain that is free, wherein each of the first plurality of unsuccessful attempts is an unsuccessful attempt to obtain a different resource instance of the first domain, wherein the first instance cursor is advanced to a next resource ID of the first domain after each of the first plurality of unsuccessful attempts;
determining whether the first plurality of unsuccessful attempts exceeds a maximum; and
responsive to determining that the first plurality of unsuccessful attempts exceeds the maximum, performing second processing including:
placing the first thread on a first wait queue associated with one resource instance of the first domain, wherein the first thread waits on the first wait queue to acquire said one resource instance of the first domain.

20. The one or more computer-readable media of claim 19, wherein said placing includes:
adding the first thread to the first wait queue based on a FIFO (first in first out) ordering in which threads attempt to acquire said one resource instance.
